(19) United States
(12) Patent Application Publication
(10) Pub. No.: US 2026/0333001 A1
(43) Pub. Date: Oct. 22, 2026

(54) METHOD FOR INCENTIVIZING TERMINAL AND COMMUNICATION APPARATUS

(71) Applicant: HUAWEI TECHNOLOGIES CO., LTD., Shenzhen (CN)

(72) Inventors: Yan Xi, Shanghai (CN); Xueqiang Yan, Shanghai (CN); Mingyu Zhao, Shanghai (CN); Junfan Wang, Shanghai (CN)

(73) Assignee: HUAWEI TECHNOLOGIES CO., LTD., Shenzhen (CN)

(21) Appl. No.: 19/703,696

(22) Filed: Jun. 10, 2026

Related U.S. Application Data
(63) Continuation of application No. PCT/CN2024/128084, filed on Oct. 29, 2024.

(30) Foreign Application Priority Data
Dec. 11, 2023 (CN) 202311699884.X

(51) Int. Cl. H04W 4/38; H04W 24/10

(52) U.S. Cl. CPC H04W 4/38; H04W 24/10

(57) ABSTRACT

This application provides element example methods for incentivizing a terminal. One example method includes obtaining an incentive policy and obtaining an incentive parameter, wherein the incentive policy and the incentive parameter are used by a second network element to collect statistics about contribution of the terminal to a sensing service. The incentive policy and the incentive parameter are sent to the second network element.

### CROSS-REFERENCE TO RELATED APPLICATIONS

This application is a continuation of International Application No. PCT/CN2024/128084, filed on Oct. 29, 2024, which claims priority to Chinese Patent Application No. 202311699884.X, filed on Dec. 11, 2023. The disclosures of the aforementioned applications are hereby incorporated by reference in their entireties.

### TECHNICAL FIELD

This application relates to the field of communication technologies, and more specifically, to a method for incentivizing a terminal and a communication apparatus.

### BACKGROUND

During the evolution of a 5th generation (5G) mobile communication system toward a 5G-advanced (5G-A) technology, an integrated sensing and communication technology is considered as one of key technologies capable of extending service capabilities of mobile communication networks. This technology aims to integrate wireless communication and sensing functions into a same system, and use various propagation characteristics of radio signals to construct capabilities of detecting and imaging targets, so that communication and sensing capabilities are integrated into one network, thereby achieving harmonious coexistence, and even mutual benefit.

In an existing network architecture, terminals are consumers of services. However, in the integrated sensing and communication technology, the terminals may serve as providers of data or signals in sensing services, and contribute their resources and capabilities to a network. Therefore, there is need for a mechanism to incentivize terminals, so that the terminals can participate in the sensing services as much as possible, thereby improving motivation and initiative of the terminals to provide resources for the sensing service.

### SUMMARY

Embodiments of this application provide a method for incentivizing a terminal and a communication apparatus, to improve motivation and initiative of a terminal to provide resources for a sensing service.

According to a first aspect, a method for incentivizing a terminal is provided. The method includes: obtaining an incentive policy and obtaining an incentive parameter, where the incentive policy and the incentive parameter are used by a second network element to collect statistics about contribution of the terminal to a sensing service; and sending the incentive policy and the incentive parameter to the second network element.

In this embodiment of this application, the method may be applied to a first network element.

The first network element may be a network element having a control function, for example, an SSCF.

In a sensing service scenario, the terminal may become a provider of data or a signal of the sensing service. This embodiment of this application provides the method for incentivizing a terminal. The first network element obtains the incentive policy and the incentive parameter, and sends the incentive policy and the incentive parameter to the second network element. The second network element collects statistics about the contribution of the terminal to the sensing service, and incentivizes the terminal based on the contribution. After receiving an incentive, the terminal more actively participates in the sensing service. In this way, a degree of participation of the terminal in the sensing service can be improved, and motivation and initiative of the terminal to contribute resources to the sensing service are improved.

With reference to the first aspect, in some implementations of the first aspect, obtaining the incentive policy includes: sending first information to a third network element, where the first information is used to request the incentive policy; and receiving the incentive policy from the third network element.

With reference to the first aspect, in some implementations of the first aspect, the incentive policy and the incentive parameter may be sent to the terminal.

In this technical solution, after receiving the incentive policy and the incentive parameter, the terminal may collect statistics about the contribution of the terminal to the sensing service.

With reference to the first aspect, in some implementations of the first aspect, obtaining the incentive policy includes: obtaining the locally configured incentive policy.

It should be understood that, a method for obtaining the incentive policy by the first network element is not unique, thereby improving flexibility during service configuration.

With reference to the first aspect, in some implementations of the first aspect, the incentive policy is preconfigured, or the incentive policy is predefined.

With reference to the first aspect, in some implementations of the first aspect, obtaining the incentive parameter includes: sending second information to a fourth network element, where the second information is used to request the incentive parameter; and receiving the incentive parameter from the fourth network element.

With reference to the first aspect, in some implementations of the first aspect, the incentive policy may include the incentive parameter.

It should be understood that, when the incentive policy includes the incentive parameter, the first network element requests the incentive parameter from the fourth network element.

With reference to the first aspect, in some implementations of the first aspect, the incentive policy includes a statistical granularity.

With reference to the first aspect, in some implementations of the first aspect, the statistical granularity includes at least one of service type-based statistics, sensing precision-based statistics, or quality of service flow-based statistics.

With reference to the first aspect, in some implementations of the first aspect, the incentive parameter includes at least one of the following: a statistical mode, a statistical event, or a threshold of the statistical event.

With reference to the first aspect, in some implementations of the first aspect, the statistical mode includes at least one of the following: traffic-based statistics, duration-based statistics, or sensing service occurrence quantity-based statistics.

With reference to the first aspect, in some implementations of the first aspect, the statistical event includes at least one of the following: traffic reaches a threshold, duration reaches a threshold, a sensing service occurrence quantity reaches a threshold, a location at which the terminal executes the sensing service changes, or a time point at which the terminal executes the sensing service changes.

With reference to the first aspect, in some implementations of the first aspect, the threshold of the statistical event includes at least one of the following: a traffic threshold, a duration threshold, or a sensing service occurrence quantity threshold.

With reference to the first aspect, in some implementations of the first aspect, the method further includes: receiving contribution information from the second network element; and sending the contribution information to the fourth network element in response to the contribution information. The contribution information is used to request the fourth network element to incentivize the terminal.

With reference to the first aspect, in some implementations of the first aspect, the method further includes: sending third information to a digital credential processing apparatus when the terminal has been subscribed to provide a sensing service, where the third information is used to request the digital credential processing apparatus to deploy an incentive smart contract.

With reference to the first aspect, in some implementations of the first aspect, the method further includes: receiving contribution information from the second network element; and sending the contribution information to the digital credential processing apparatus in response to the contribution information. The contribution information is used to request the digital credential processing apparatus to incentivize the terminal.

With reference to the first aspect, in some implementations of the first aspect, the second network element includes any one of a processing network element or a base station, the third network element includes a policy network element, and the fourth network element includes a charging network element.

The second network element may be a network element having a processing function, for example, an SDPF.

The third network element may be a network element having a policy function, for example, a PCF.

The fourth network element may be a network element having a charging function, for example, a CHF.

According to a second aspect, a method for incentivizing a terminal is provided. The method includes: receiving sensing data, and determining contribution information of the terminal based on the sensing data; and sending the contribution information of the terminal to a first network element. The contribution information indicates the first network element to send the contribution information to a fourth network element.

In this embodiment of this application, the method may be applied to a second network element.

In this technical solution, the second network element may determine, based on the sensing data, the contribution information of the terminal when the terminal executes a sensing service, to quantify contribution, and further incentivize the terminal. After receiving an incentive, the terminal more actively participates in the sensing service. In this way, a degree of participation of the terminal in the sensing service can be improved, and motivation and initiative of the terminal to contribute resources to the sensing service are improved.

With reference to the second aspect, in some implementations of the second aspect, the method further includes: receiving an incentive policy and an incentive parameter. The incentive policy and the incentive parameter are used to collect statistics about contribution of the terminal to a sensing service.

In this technical solution, the second network element may analyze the sensing data based on the incentive policy and the incentive parameter, to better collect statistics about the contribution of the terminal.

With reference to the second aspect, in some implementations of the second aspect, the incentive policy includes a statistical granularity.

With reference to the second aspect, in some implementations of the second aspect, the statistical granularity includes at least one of service type-based statistics, sensing precision-based statistics, or quality of service flow-based statistics.

With reference to the second aspect, in some implementations of the second aspect, the incentive parameter includes at least one of the following: a statistical mode, a statistical event, or a threshold of the statistical event.

With reference to the second aspect, in some implementations of the second aspect, the statistical mode includes at least one of the following: traffic-based statistics, duration-based statistics, or sensing service occurrence quantity-based statistics.

With reference to the second aspect, in some implementations of the second aspect, the statistical event includes at least one of the following: traffic reaches a threshold, duration reaches a threshold, a sensing service occurrence quantity reaches a threshold, a location at which the terminal executes the sensing service changes, or a time point at which the terminal executes the sensing service changes.

With reference to the second aspect, in some implementations of the second aspect, the threshold of the statistical event includes at least one of the following: a traffic threshold, a duration threshold, a service occurrence quantity threshold, or a sensing precision threshold.

According to a third aspect, a method for incentivizing a terminal is provided. The method includes: receiving first information sent by a first network element, where the first information is used by the first network element to request an incentive policy; and sending the incentive policy to the first network element.

In this embodiment of this application, the method may be applied to a third network element.

In this technical solution, the third network element provides the incentive policy for the first network element. The incentive policy is used to collect statistics about contribution of the terminal to a sensing service, and the incentive policy provides a plurality of dimensions for collecting statistics about the contribution of the terminal, so that statistics collection is more flexible and accurate.

With reference to the third aspect, in some implementations of the third aspect, the incentive policy includes a statistical granularity.

With reference to the third aspect, in some implementations of the third aspect, the statistical granularity includes at least one of service type-based statistics, sensing precision-based statistics, or quality of service flow-based statistics.

According to a fourth aspect, a method for incentivizing a terminal is provided. The method includes: receiving second information sent by a first network element, where the second information is used by the first network element to request an incentive parameter; and sending the incentive parameter to the first network element.

In this embodiment of this application, the method may be applied to a fourth network element.

In this technical solution, the fourth network element provides the incentive parameter for the first network element. The incentive parameter is used to collect statistics about contribution of the terminal to a sensing service. In this way, statistics about contribution information of the terminal can be better collected.

With reference to the fourth aspect, in some implementations of the fourth aspect, the incentive parameter includes at least one of the following: a statistical mode, a statistical event, or a threshold of the statistical event.

With reference to the fourth aspect, in some implementations of the fourth aspect, the statistical mode includes at least one of the following: traffic-based statistics, duration-based statistics, or sensing service occurrence quantity-based statistics.

With reference to the fourth aspect, in some implementations of the fourth aspect, the statistical event includes at least one of the following: traffic reaches a threshold, duration reaches a threshold, a sensing service occurrence quantity reaches a threshold, a location of the terminal changes, or a time point at which the terminal starts to execute a service changes.

With reference to the fourth aspect, in some implementations of the fourth aspect, the threshold of the statistical event includes at least one of the following: a traffic threshold, a duration threshold, or a service occurrence quantity threshold.

With reference to the fourth aspect, in some implementations of the fourth aspect, the method further includes: receiving contribution information sent by the first network element, and incentivizing the terminal based on the contribution information.

According to a fifth aspect, a method for incentivizing a terminal is provided. The method includes: receiving third information sent by a first network element, where the third information is used by the first network element to request to deploy an incentive smart contract; and deploying the incentive smart contract. The incentive smart contract is used to collect statistics about or is associated with contribution of a terminal.

With reference to the fifth aspect, in some implementations of the fifth aspect, deploying the incentive smart contract includes: deploying the incentive smart contract based on an incentive parameter.

According to a sixth aspect, a communication apparatus is provided. The communication apparatus is configured to perform the method according to the first aspect to the fourth aspect.

According to a seventh aspect, a communication apparatus is provided, including a processor, configured to execute a computer program stored in a memory, so that the communication apparatus performs the method according to the first aspect to the fourth aspect.

According to an eighth aspect, an electronic apparatus is provided. The electronic apparatus is configured to perform the method according to the fifth aspect.

According to a ninth aspect, an electronic apparatus is provided, including a processor, configured to execute a computer program stored in a memory, so that the electronic apparatus performs the method according to the fifth aspect.

According to a tenth aspect, a computer-readable storage medium is provided. The computer-readable storage medium stores a computer program, and when the computer program is run on a computer, the computer is enabled to perform the method according to the first aspect to the fifth aspect.

According to an eleventh aspect, a computer program product is provided. The computer program product includes instructions used to perform the method according to the first aspect to the fifth aspect.

According to a twelfth aspect, a chip system is provided, including a processor, configured to: invoke a computer program from a memory and run the computer program, so that a device in which the chip system is installed performs the method according to the first aspect to the fifth aspect.

### BRIEF DESCRIPTION OF DRAWINGS

FIG. 1A to FIG. 1F are diagrams of sensing scenarios applicable to an embodiment of this application;

FIG. 2 is a diagram of a network architecture applicable to an embodiment of this application;

FIG. 3 is a schematic interaction flowchart of a method for incentivizing a terminal according to an embodiment of this application;

FIG. 4A and FIG. 4B are an interaction diagram of a method for incentivizing a terminal according to an embodiment of this application;

FIG. 5A and FIG. 5B are an interaction diagram of another method for incentivizing a terminal according to an embodiment of this application;

FIG. 6A and FIG. 6B are an interaction diagram of another method for incentivizing a terminal according to an embodiment of this application;

FIG. 7 is a schematic flowchart of deploying an incentive smart contract in a digital credential processing apparatus, which is applicable to an embodiment of this application;

FIG. 8A and FIG. 8B are an interaction diagram of another method for incentivizing a terminal according to an embodiment of this application;

FIG. 9A and FIG. 9B are an interaction diagram of another method for incentivizing a terminal according to an embodiment of this application;

FIG. 10 is a block diagram of a structure of a communication apparatus applicable to an embodiment of this application;

FIG. 11 is a block diagram of a structure of another communication apparatus applicable to an embodiment of this application; and

FIG. 12 is a block diagram of a structure of an electronic apparatus applicable to an embodiment of this application.

### DESCRIPTION OF EMBODIMENTS

The following describes technical solutions of embodiments in this application with reference to accompanying drawings.

The technical solutions provided in this application may be applied to various communication systems, such as a 5th generation (5G) or new radio (NR) system, a long term evolution (LTE) system, an LTE frequency division duplex (FDD) system, and an LTE time division duplex (TDD) system. The technical solutions provided in this application may be further applied to a future communication system, for example, a 6th generation mobile communication system. The technical solutions provided in this application may be further applied to device-to-device (D2D) communication, vehicle-to-everything (V2X) communication, machine-to-machine (M2M) communication, machine type communication (MTC), an internet of things (IoT) communication system, or another communication system.

UE in embodiments of this application includes various devices having a wireless communication function, and the UE may be configured to be connected to a person, an object, a machine, and the like. The UE may be widely used in various scenarios, such as cellular communication, D2D, V2X, peer-to-peer (P2P), M2M, MTC, IoT, virtual reality (VR), augmented reality (AR), industrial control, autonomous driving, telemedicine, smart grid, smart furniture, smart office, smart wearable, smart transportation, smart city, an uncrewed aerial vehicle, robot, remote sensing, passive sensing, positioning, navigation and tracking, and autonomous delivery. The UE may be a terminal in any one of the foregoing scenarios, for example, an MTC terminal or an IoT terminal. The UE may be user equipment (UE) in a 3rd generation partnership project (3GPP) standard, a terminal, a fixed device, a mobile station device, namely, a mobile device, a subscriber unit, a handheld device, a vehicle-mounted device, a wearable device, a cellular phone, a smartphone, a SIP phone, a wireless data card, a personal digital assistant (PDA), a computer, a tablet computer, a notebook computer, a wireless modem, a handheld device, a laptop computer, a computer having a wireless transceiver function, a smart book, a vehicle, a satellite, a global positioning system (GPS) device, a target tracking device, a flight device (for example, an uncrewed aerial vehicle, a helicopter, a multi-helicopter, a four-helicopter, or an airplane), a ship, a remote control device, a smart home device, or an industrial device; or may be an apparatus built in the foregoing device (for example, a communication module, a modem, or a chip in the foregoing device), or may be another processing device connected to the wireless modem. For ease of description, the following describes the UE by using a terminal or the UE as an example.

In embodiments of this application, an apparatus configured to implement a function of the UE may be the UE, or may be an apparatus that can support the UE in implementing the function, for example, a chip system or a chip. The apparatus may be installed in the UE. In embodiments of this application, the chip system may include a chip, or may include a chip and another discrete component.

A network device in embodiments of this application may be a device configured to communicate with the UE. The network device may also be referred to as an access network device or a radio access network device. For example, the network device may be a base station. In embodiments of this application, the network device may be a radio access network (RAN) node (or device) that connects the UE to a wireless network. The base station may cover various names in the following in a broad sense, or may be replaced with the following names, such as a NodeB, an evolved NodeB (eNB), a next generation NodeB (gNB), a relay station, an access point, a transmitting and receiving point (TRP), a transmitting point (TP), a primary station, a secondary station, a multi-standard radio node, a home eNodeB, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), or a positioning node. The base station may be a macro base station, a micro base station, a relay node, a donor node, or the like, or a combination thereof. The base station may alternatively be a communication module, a modem, or a chip disposed in the foregoing device or apparatus. The base station may alternatively be a mobile switching center, a device that bears a base station function in D2D, V2X, and M2M communication, a network side device in a 6G network, a device that bears a base station function in a future communication system, or the like. The base station may support networks of a same access technology or different access technologies. A specific technology and a specific device form that are used by the network device are not limited in embodiments of this application.

In embodiments of this application, an apparatus configured to implement a function of the network device may be UE, or may be an apparatus that can support the network device in implementing the function, for example, a chip system or a chip. The apparatus may be installed in the network device. In this embodiment of this application, the chip system may include a chip, or may include a chip and another discrete component.

The network device and the UE may be deployed on land, including being deployed indoor or outdoor, being handheld, or being vehicle-mounted; may be deployed on the water; or may be deployed on an airplane, a balloon, and a satellite in the air. Scenarios in which the network device and the UE are located are not limited in embodiments of this application.

For ease of understanding of embodiments of this application, terms in embodiments of this application are first briefly described below.

### Integrated Sensing and Communication (ISAC):

In the communication field, communication and sensing functions may be integrated, so that a communication system has both the communication and sensing functions. The communication system not only supports information transmission on a radio channel, but also supports active cognition and analysis of channel characteristics to sense physical features of a surrounding environment, thereby implementing mutual enhancement of the communication and sensing functions. In the integrated sensing and communication technology, a sensing device may send a sensing signal, and receive a signal (also referred to as an echo signal) obtained after the sent sensing signal is reflected by a sensed target, to determine attribute information of the sensed target, for example, information such as a speed, a distance, a shape, or a size of the sensed target. The sensed target may be a fixed object, for example, a mountain, a forest, or a building, or may be a movable object, for example, a vehicle, an uncrewed aerial vehicle, a pedestrian, or UE. The sensing device may also be referred to as a sensing apparatus, or may be referred to as a detector, or the like, or may be referred to as a communication device (for example, UE or an access network device) having a sensing function. The sensing function may include at least a capability of sending a sensing signal and receiving an echo signal of the sensing signal.

### Self-Sensing:

In embodiments of this application, self-sensing is to implement sensing measurement on a sensed target by receiving a self-sent sensing signal. For example, in wireless communication, self-sensing may include sensing of a transmit power, sensing of signal quality, and the like. For example, a transmitting end transmits a sensing signal, and the sensing signal is received by the transmitting end after being reflected by the sensed target. The transmitting end may obtain a distance from the sensed target based on transmit time and receive time of the sensing signal. The self-sensing technology is applied to many fields, such as smart transportation, smart city, and smart home. Self-sensing may also be referred to as a monostatic sensing mode. In a sensing signal procedure, a sensing site not only needs to send a sensing signal, but also needs to receive a signal obtained after the sensing signal is reflected on a target surface. Therefore, the monostatic sensing mode is also referred to as a self-sending and self-receiving mode.

### Transmit-Receive Separated Sensing:

In embodiments of this application, transmit-receive separated sensing means that receiving and sending functions are separately performed. Transmit-receive separated sensing can achieve better signal receiving and sending effect, and can also reduce system complexity and improve system stability. For example, a transmit-receive separated sensing system includes two parts: a transmitting end and a receiving end. The transmitting end is responsible for transmitting a sensing signal. The sensing signal is received by the receiving end after being reflected by a sensed target. The receiving end processes the sensing signal to obtain information about the sensed target. The transmit-receive separated sensing technology is applied to many fields, such as wireless communication, satellite communication, and radar. This technology can improve transmission efficiency and reliability of a communication system, and can also reduce complexity and costs of the system. Bistatic sensing is also referred to as a bistatic sensing mode. In a sensing signal procedure, the transmitting end and the receiving end of the sensing signal are two different devices. In the sensing signal procedure, after a sensing site A sends a sensing signal, a signal obtained after the signal is reflected on a target surface is received by a sensing site B. Therefore, the bistatic sensing mode is also referred to as an A-transmits-B-receives mode.

It may be understood that, in a monostatic sensing scenario, an access network device may perform self-sending and self-receiving, or UE may perform self-sending and self-receiving. In a bistatic sensing scenario, an access network device A may perform sending, and an access network device B may perform receiving; or an access network device may perform sending, and UE may perform receiving; or UE may perform sending, and an access network device may perform receiving; or UE #1 may perform sending, and UE #2 may perform receiving.

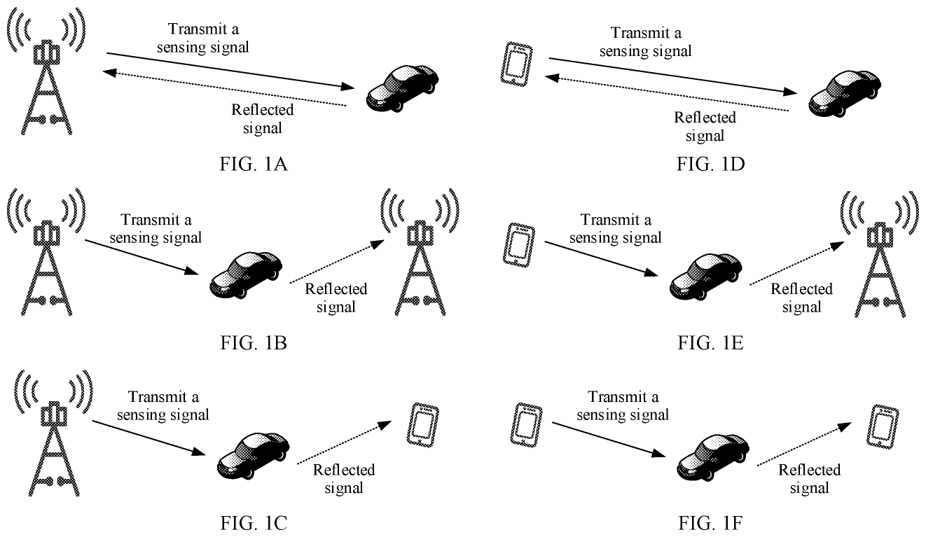

FIG. 1A to FIG. 1F are diagrams of sensing scenarios applicable to an embodiment of this application. FIG. 1A to FIG. 1F show six sensing scenarios.

FIG. 1A shows a sensing scenario in which an access network device A performs self-sending and self-receiving. The access network device A transmits a sensing signal, and the access network device A receives a reflected signal generated when the sensing signal encounters a target in an environment, to sense information such as a location and a speed of the target. FIG. 1B shows a sensing scenario in which an access network device A performs sending, and an access network device B performs receiving. The access network device A transmits a sensing signal, and the access network device B receives a reflected signal generated when the sensing signal encounters a target in an environment, so that the access network device B senses information such as a location and a speed of the target. FIG. 1C shows a sensing scenario in which an access network device A performs sending, and UE performs receiving. The access network device A transmits a sensing signal, and the UE receives a reflected signal generated when the sensing signal encounters a target in an environment, so that the UE senses information such as a location and a speed of the target.

FIG. 1D shows a sensing scenario in which UE performs self-sending and self-receiving. UE #1 transmits a sensing signal, and the UE #1 receives a reflected signal generated when the sensing signal encounters a target in an environment, to sense information such as a location and a speed of the target. FIG. 1E shows a sensing scenario in which UE #1 performs sending, and an access network device performs receiving. The UE #1 transmits a sensing signal, and an access network device B receives a reflected signal generated when the sensing signal encounters a target in an environment, so that the access network device B senses information such as a location and a speed of the target. FIG. 1F shows a sensing scenario in which UE #1 performs sending, and UE #2 performs receiving. The UE #1 transmits a sensing signal, and the UE #2 receives a reflected signal generated when the sensing signal encounters a target in an environment, so that the UE #2 senses information such as a location and a speed of the target.

The foregoing sensing scenarios are merely examples for description, and constitute no limitation on this embodiment of this application.

In this embodiment of this application, sensed targets include various tangible objects that can reflect an electromagnetic wave in an environment, such as a ground object, for example, a mountain, a forest, or a building, and may further include a movable object such as a vehicle, an uncrewed aerial vehicle, a pedestrian, or UE. The sensed target may also be referred to as a target, a detected target, a sensed object, a detected object, a sensed device, or the like. This is not limited in this embodiment of this application.

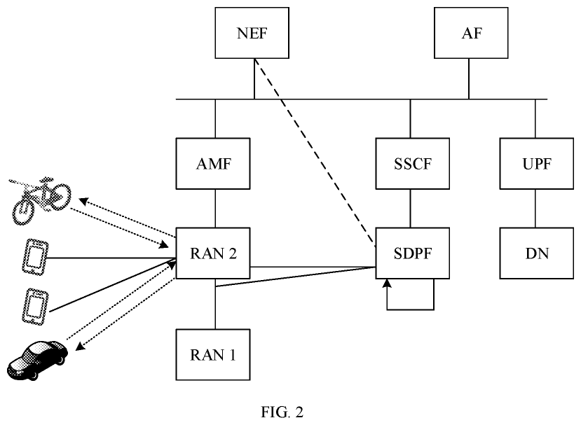

FIG. 2 is a diagram of a network architecture applicable to an embodiment of this application.

As shown in FIG. 2, the network architecture includes but is not limited to the following network elements:

### 1. Network Exposure Function (NEF) Network Element:

The NEF network element is configured to securely open, to the outside, a service, a capability, and the like provided by a 3GPP network function, and mainly supports secure interaction between a 3GPP network and a third-party application.

### 2. Application Function (AF) Network Element:

The AF network element is configured to: perform data routing affected by an application, access a network exposure function network element, or interact with a policy framework to perform policy control, or the like, for example, affect a data routing decision, affect a policy control function, or provide some third-party services for a network side.

### 3. Access and Mobility Management Function (AMF) Network Element:

The AMF network element is mainly used for mobility management, access management, and the like, and may be configured to implement functions, for example, lawful interception and access authorization/authentication, other than session management in functions of a mobility management entity (MME) in an LTE system. When serving a session of user equipment, the AMF network element provides control plane storage resources for the session, and stores a session identifier, a session management function (SMF) network element identifier associated with the session identifier, and the like. In this embodiment of this application, the AMF network element may be configured to implement a function of an access and mobility management network element.

### 4. User Plane Function (UPF) Network Element:

The UPF network element may be configured to: perform packet routing and forwarding, perform quality of service (QoS) processing on user plane data, or the like. User data may be accessed by a data network (DN) through the network element, or may be received from the data network and transmitted to user equipment through an access network device. A transmission resource and a scheduling function that are used by the UPF network element to serve user equipment are managed and controlled by an SMF network element. In this embodiment of this application, the UPF network element may be configured to implement a function of a user plane network element.

### 5. Access Device (AN):

The access device in this embodiment of this application may be a device configured to communicate with user equipment, and the access device may also be referred to as an access network device or a radio access network device. For example, the access device may be an evolved NodeB (eNB or eNodeB) in an LTE system; or may be a radio controller in a cloud radio access network (CRAN) scenario; or the access device may be a relay station, an access point, a vehicle-mounted device, a wearable device, an access device in a 5G network, or an access device in a future evolved PLMN network; or may be an access point (AP) in a WLAN; or may be a gNB in an NR system. This is not limited in this embodiment of this application. FIG. 2 shows two RAN devices, namely, a RAN 1 and a RAN 2.

In addition, in this embodiment of this application, the access device is a device in a RAN. In other words, the access device is a RAN node that connects the user equipment to a wireless network. For example, by way of example rather than limitation, the access device may be a gNB, a transmission reception point (TRP), an evolved NodeB (eNB), a radio network controller (RNC), a NodeB (NB), a base station controller (BSC), a base transceiver station (BTS), a home evolved NodeB (for example, a home evolved NodeB or a home NodeB, HNB), a baseband unit (BBU), or a wireless fidelity (Wi-Fi) access point (AP). In a network structure, a network device may include a central unit (CU) node, a distributed unit (DU) node, a RAN device including a CU node and a DU node, or a RAN device including a CU-control plane node (CU-CP node), a CU-user plane node (CU-UP node), and a DU node. In different systems, the CU (or the CU-CP and the CU-UP), the DU, or the RU may also have different names, but a person skilled in the art may understand meanings thereof. For example, in an open access network (open RAN, O-RAN or ORAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, in this embodiment of this application, the CU, the CU-CP, the CU-UP, the DU, and the RU are used as examples for description. In this embodiment of this application, any unit in the CU (or the CU-CP or the CU-UP), the DU, and the RU may be implemented by a software module, a hardware module, or a combination of a software module and a hardware module.

The access device may serve a cell. User equipment communicates with the access device on a transmission resource (for example, a frequency domain resource, in other words, a frequency spectrum resource) used by the cell. The cell may be a cell corresponding to the access device (for example, a base station). The cell may belong to a macro base station, or a base station corresponding to a small cell. The small cell herein may include a metro cell, a micro cell, a pico cell, a femto cell, or the like. These small cells have features of a small coverage area and a low transmit power, and are applicable to providing a high-speed data transmission service.

In addition, a plurality of cells may simultaneously operate at a same frequency on a carrier in the LTE system or the 5G system. In some special scenarios, it may also be considered that a concept of the carrier is equivalent to a concept of a cell. For example, in a carrier aggregation (CA) scenario, when a secondary component carrier is configured for UE, both a carrier index of the secondary component carrier and a cell identifier (Cell ID) of a secondary cell that operates on the secondary component carrier are carried. In this case, it may be considered that a concept of a carrier is equivalent to a concept of a cell. For example, accessing a carrier by the user equipment is equivalent to accessing a cell by the user equipment.

A communication system in this application may be further applied to a vehicle to everything (V2X) technology. To be specific, the user equipment in this application may alternatively be a vehicle, for example, an intelligent vehicle or an autonomous vehicle.

“X” in V2X represents different communication targets, and the V2X may include but is not limited to vehicle to vehicle (V2V), vehicle to infrastructure (V2I), vehicle to network (V2N), and vehicle to pedestrian (V2P).

In the V2X, the access device may configure a “zone” for the UE. The zone may also be referred to as a geographical zone. After the zone is configured, the world is divided into a plurality of zones, and the zones are defined by reference points, lengths, and widths. When determining a zone identifier (ID), the UE uses a zone length, a zone width, a quantity of zones along the length, a quantity of zones along the width, and a zone reference point to perform a modulo operation. The foregoing information may be configured by the access device.

A V2X service may be provided in two manners: a proximity-based services communication (proximity-based services communication 5, PC5) interface manner and a Uu interface-based manner. The PC5 interface is an interface defined based on a sidelink. Through such an interface, communication devices (for example, vehicles) may directly communicate with each other. The PC5 interface may be used out of coverage (out of coverage, OOC) and in coverage (IC), but only an authorized communication device can use the PC5 interface for transmission.

The access network device in this embodiment of this application has a sensing capability, and may serve as a sensing entity to send a sensing signal to a sensed target and receive a sensing echo signal. Alternatively, an echo signal may be received by another sensing entity. Alternatively, the access network device may receive an echo signal of a sensing signal sent by another sensing entity. For details, refer to the scenarios in FIG. 1A to FIG. 1F. This is not limited in this embodiment of this application.

### 6. Sensing Service Control Function (SSCF):

Main functions of the SSCF are to receive capability registration of a sensing entity and implement orchestration of a sensing service.

In a capability registration phase of the sensing entity, the sensing entity may send a capability registration request message to the SSCF. The capability registration request message includes parameters such as indication information of the sensing entity, indication information of an adjacent sensing entity of the sensing entity, location information of the sensing entity, and a sensing range of the sensing entity. After registration is completed, the SSCF may send a sensing capability registration response message to the sensing entity, to notify the sensing entity that the sensing capability is registered.

The indication information of the sensing entity may be an identifier or a name of the sensing entity. This is not limited in this embodiment of this application.

In an orchestration phase of the sensing service, the SSCF may determine a sending entity and a receiving entity of a sensing signal based on a service requirement. For example, the SSCF may select a proper sensing entity as the sending entity based on a sensing service request, and send a sensing control message to a RAN. The sensing control message may include a sensing signal Tx, a sensing type, a key performance indicator (KPI) of the sensing service, and the like. Similarly, the SSCF may select a proper sensing entity as the receiving entity based on the sensing service request, and send a sensing control message to UE. The sensing control message may include a sensing signal Rx, a sensing type, and the like.

The SSCF may communicate with another network function (NF) through a service-based interface (SBI).

### 7. Sensing Data Processing Function (SDPF):

The SDPF is configured to process sensing service data.

A sensing entity may send original sensing data to the SDPF. The SDPF may calculate sensing measurement data based on the original sensing data, calculate a sensing result based on the sensing measurement data, and send a processing result to a DN. For example, the SDPF may send the processing result to the DN through an NEF or a gateway (GW). This is not limited in this embodiment of this application.

The SDPF may be communicatively connected to an SBI bus, or a separate interface may be defined.

In this embodiment of this application, the RAN and the SSCF may be directly connected, or may communicate through the AMF. This is not limited in this embodiment of this application.

In this embodiment of this application, sensing data of the RAN or the UE may be forwarded to the SDPF through the UPF, or may be directly sent to the SDPF. This is not limited in this embodiment of this application.

In addition to the network elements shown in FIG. 2, the network architecture provided in this application may further include the following network elements:

A policy control network element is a unified policy framework for guiding a network behavior, and provides policy rule information, and the like for a control plane function network element (for example, the AMF network element or the SMF network element).

In a 4G communication system, the policy control network element may be a policy and charging rules function (PCRF) network element. In a 5G communication system, the policy control network element may be a policy control function (PCF) network element. In a future communication system, the policy control network element may still be the PCF network element, or may have another name. This is not limited in this application.

A charging function (CHF) network element mainly provides a charging service and a bandwidth control service. The CHF network element provides a convergent charging (Nchf_ConvergedCharging) service and an offline charging (Nchf_OfflineOnlyCharging) service for a session management network element, to complete functions such as rating and quota management. The CHF network element provides a bandwidth control (Nchf_SpendingLimitControl) service for the policy control network element, to complete bandwidth control and change notification.

It should be understood that, all the network architectures shown above is merely examples for description, and the network architecture applicable to this embodiment of this application is not limited thereto. Any network architecture that can implement functions of the network elements is applicable to this embodiment of this application.

It should be further understood that the functions or network elements shown in FIG. 2 may be understood as network elements configured to implement different functions, for example, may be combined into a network slice based on a requirement. These network elements may be independent devices, may be integrated into a same device to implement different functions, may be network elements in a hardware device, may be software functions running on dedicated hardware, or may be virtualization functions instantiated on a platform (for example, a cloud platform). Specific forms of the network elements are not limited in this application.

It should be further understood that the foregoing names are defined merely for distinguishing between different functions, and should not constitute any limitation on this application. This application does not exclude a possibility of using other names in a 6G network and another future network. For example, in the 6G network, a part or all of the foregoing network elements may still use terms in 5G, or may use other names.

In embodiments of this application, in the integrated communication technology, a terminal may become a provider of data or a signal in a sensing service, and the terminal may contribute resources and capabilities of the terminal to a network. Therefore, a method for incentivizing a terminal is needed. The terminal can be enabled to participate in the sensing service as much as possible, thereby improving motivation and initiative of the terminal to provide resources for the sensing service.

In view of this, embodiments of this application provide a method for incentivizing a terminal, to properly measure a sensing service provided by a terminal, and incentivize the terminal based on contribution of the terminal.

With reference to the accompanying drawings, the following describes in detail the method for incentivizing a terminal and a communication apparatus that are provided in embodiments of this application.

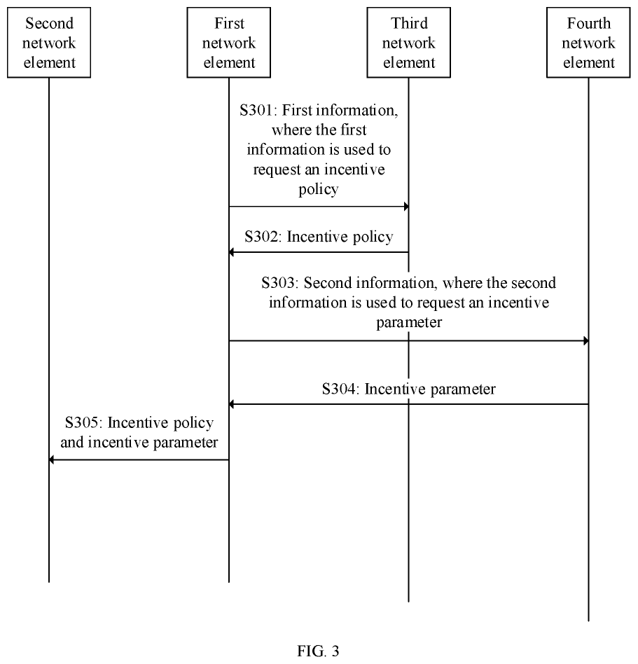

FIG. 3 is a schematic interaction flowchart of a method for incentivizing a terminal according to an embodiment of this application. As shown in FIG. 3, the method includes the following steps.

A first network element obtains an incentive policy and obtains an incentive parameter. The incentive policy and the incentive parameter are used by a second network element to collect statistics about contribution of a terminal to a sensing service; and
sends the incentive policy and the incentive parameter to the second network element.

In a possible implementation, obtaining the incentive policy includes:

S301: The first network element sends first information to a third network element, where the first information is used to request the incentive policy.

S302: The third network element sends the incentive policy to the first network element.

Correspondingly, the third network element receives the first information sent by the first network element. The first information is used by the first network element to request the incentive policy.

The third network element sends the incentive policy to the first network element.

In another embodiment provided in this application, the first network element alternatively obtains the incentive policy in another method. For example, the first network element does not send the first information. In this case, the first network element may obtain the locally configured incentive policy.

In an example, the incentive policy includes a statistical granularity, and the statistical granularity includes at least one of service type-based statistics, sensing precision-based statistics, or quality of service flow-based statistics.

In an example, service type-based statistics means that if a terminal may simultaneously execute a plurality of same-class sensing services, statistics about the plurality of same-class sensing services executed by the terminal may be collected. For another example, terminals that execute same-class sensing services may be grouped into one group, and same-level statistics collection and incentivization are performed on the group of terminals. Sensing precision-based statistics means that when a terminal executes a plurality of sensing services, if the terminal achieves a same level of sensing precision in the plurality of sensing services, statistics about the plurality of sensing services executed by the terminal may be collected simultaneously. For another example, terminals having a same level of precision when executing the sensing service may be grouped into one group, and same-level statistics collection and incentivization are performed on the group of terminals. Quality of service flow-based statistics means that when a terminal simultaneously executes a plurality of sensing services and is at a same quality of service flow level in the plurality of sensing services, statistics about the plurality of sensing services executed by the terminal may be collected simultaneously. For another example, terminals that are at a same quality of service flow level when executing the sensing service may be grouped into one group, and same-level statistics collection and incentivization are performed on the group of terminals.

S303: The first network element sends second information to a fourth network element, where the second information is used to request the incentive parameter.

S304: The fourth network element sends the incentive parameter to the first network element.

Correspondingly, the fourth network element receives the second information sent by the first network element. The second information is used to request the incentive parameter.

The fourth network element sends the incentive parameter to the first network element.

In an example, the incentive parameter includes but is not limited to a statistical mode, a statistical event, or a threshold of the statistical event. The statistical mode includes but is not limited to traffic-based statistics, duration-based statistics, or sensing service occurrence quantity-based statistics.

In an example, the statistical event includes but is not limited to the following: traffic reaches a threshold, duration reaches a threshold, a service occurrence quantity reaches a threshold, a location at which the terminal executes the sensing service changes, or a time point at which the terminal executes the sensing service changes.

In an example, the threshold of the statistical event includes but is not limited to a traffic threshold, a duration threshold, or a sensing service time point change.

In another embodiment provided in this application, the incentive policy may alternatively include the incentive parameter. If the incentive policy obtained by the first network element includes the incentive parameter, the first network element does not need to obtain the incentive parameter from the fourth network element.

S305: The first network element sends the incentive policy and the incentive parameter to the second network element.

In another embodiment provided in this application, the first network element may deliver the incentive policy and the incentive parameter to the terminal. In this case, the terminal can collect statistics about the contribution of the terminal.

The solution in this embodiment of this application is briefly described below.

In the following embodiments, the first network element may be a control network element, and the control network element is a network element that can receive capability registration of a sensing entity and implement orchestration of the sensing service. An SSCF is used as an example for description. The second network element may be a processing network element or a base station, and is a network element that can process sensing data. An SDPF is used as an example for description. The third network element may be a policy network element, is a unified policy framework that can guide a network behavior, and is a network element that provides policy rule information for another network element. A PCF is used as an example for description. The fourth network element may be a charging network element, and is a network element that can provide a charging service. A CHF is used as an example for description.

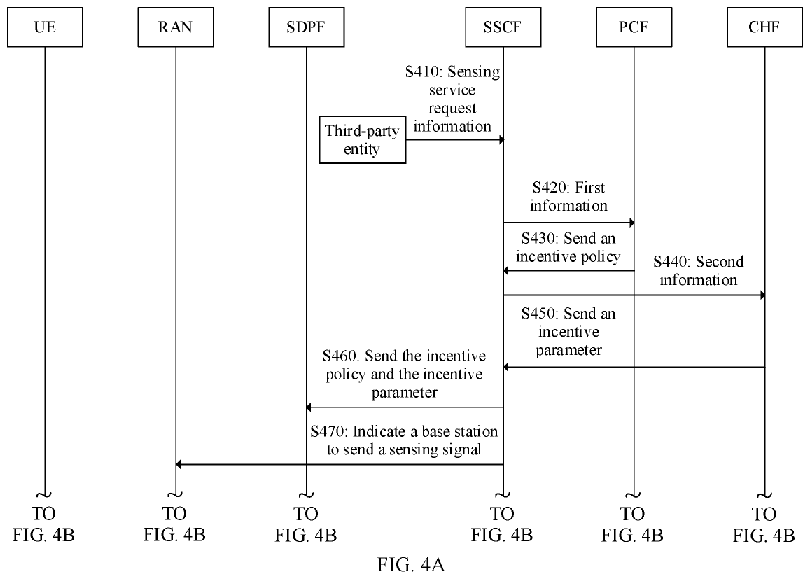

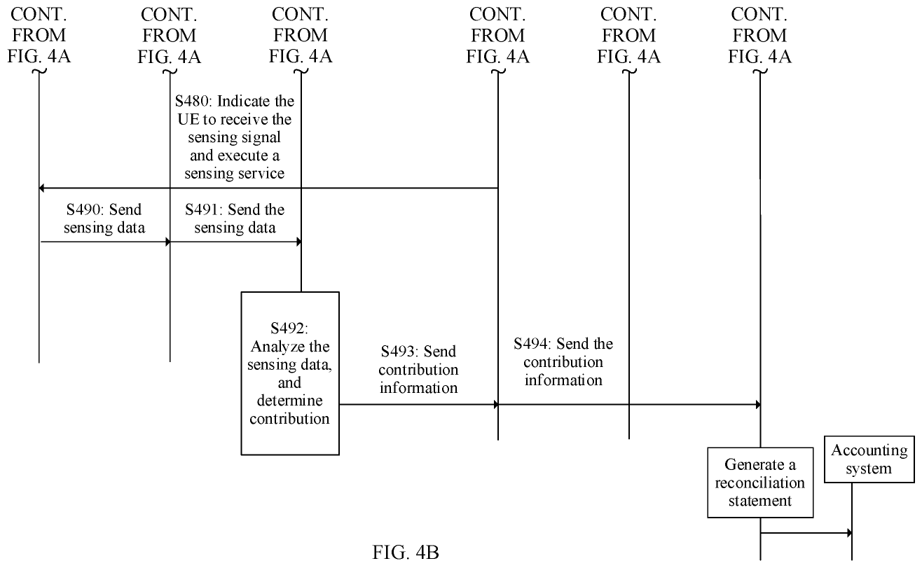

It should be understood that, in FIG. 4A to FIG. 9B, a third-party entity is a consumer of sensing data, and a sensing entity is a producer of the sensing data. The sensing entity may be UE or a RAN, and the RAN is a radio access device. The following provides descriptions by using an example in which the RAN is a base station.

FIG. 4A and FIG. 4B are an interaction diagram of a method for incentivizing a terminal according to an embodiment of this application.

S410: A third-party entity sends sensing service request information to an SSCF. The SSCF receives the sensing service request information from the third-party entity.

The third-party entity may be UE in the interaction diagram, or may be another entity that requests a sensing service.

The sensing service request information may include a sensing service identifier, and the sensing service identifier is used to identify a sensing service type requested by the third-party entity.

The sensing service type is a sensing service type that may be provided by a sensing entity, and may include but is not limited to one or more of the following types: an environment type, a monitoring type, an imaging type, a positioning type, and the like. The environment type may include but is not limited to one or more of an ambient temperature, ambient humidity, air quality, a weather condition, crowd density, vehicle flow density, atmospheric pressure, and the like. The monitoring type may include but is not limited to one or more of monitoring such as movement monitoring, intrusion monitoring, fall monitoring, and health monitoring. The movement monitoring may include but is not limited to one or more of distance monitoring, location monitoring, movement speed monitoring, movement path monitoring, and the like. The health monitoring may include but is not limited to one or more of information such as a breathing frequency and heartbeats. The imaging type may include but is not limited to one or more of medical imaging, 3D map imaging, 3D map construction, building imaging, body temperature imaging, and the like.

S411 (not shown in FIG. 4A or FIG. 4B): The SSCF determines that the sensing entity includes a terminal.

It should be understood that, in the sensing service, a sensing entity that may perform the sensing service may be a network device or a terminal, and one or more sensing entities may perform the sensing service. In this embodiment of this application, because the terminal needs to be incentivized, the SSCF needs to determine that the sensing entity that executes the sensing service includes the terminal, and then continues to execute a corresponding incentive procedure.

The SSCF may determine, based on a device type, that the sensing entity includes the terminal. The terminal needs to be incentivized only when the sensing entity includes the terminal. If the sensing entity is a network device, the network device does not need to be incentivized.

S420: The SSCF sends first information to a PCF, where the first information is used to request an incentive policy. The PCF receives the first information.

When determining that the sensing entity includes the terminal, the SSCF sends the first information to the PCF to request the incentive policy.

S430: The PCF receives the first information sent by the SSCF, where the first information is used by the SSCF to request the incentive policy; and sends the incentive policy to the SSCF. The SSCF receives the incentive policy sent by the PCF.

S440: The SSCF sends second information to a CHF, where the second information is used to request an incentive parameter. The CHF receives the second information.

S450: The CHF receives the second information sent by the SSCF, where the second information is used by the SSCF to request the incentive parameter; and sends the incentive parameter to the SSCF. The SSCF receives the incentive parameter.

S460: The SSCF sends the incentive policy and the incentive parameter to an SDPF, where the incentive policy and the incentive parameter are used by the SDPF to collect statistics about contribution of the terminal in the sensing service. The SDPF receives the incentive policy and the incentive parameter.

In another embodiment provided in this application, the SSCF may alternatively directly send the incentive policy and the incentive parameter to a base station, and indicate the base station to collect statistics about the contribution of the terminal to the sensing service.

The incentive policy includes a statistical granularity, and the statistical granularity includes at least one of service type-based statistics, sensing precision-based statistics, and quality of service flow-based statistics.

In consideration that requirements for different types of sensing services are different, there may be statistical granularities for different types of sensing services. In an example, an incentive granularity of the terminal may be determined based on a sensing service type executed by the terminal. For example, when the sensing service type executed by the terminal is the environment type, it is determined that the terminal is at a first incentive level. When the sensing service type executed by the terminal is the monitoring type, it is determined that the terminal is at a second incentive level. If a plurality of terminals execute a same type of sensing service, for example, the plurality of terminals execute an environment type of sensing service, it may be determined that these terminals are all at the first incentive level. A difference between different incentive levels may be different incentive degrees. It should be understood that, as described above, there may be more detailed classification into sensing service types. The environment type of sensing service may include but is not limited to one or more of an ambient temperature, ambient humidity, air quality, a weather condition, crowd density, vehicle flow density, atmospheric pressure, and the like. Alternatively, statistics may be collected based on a specific type. This is not limited in this embodiment of this application. For example, when an incentive standard is 10 yuan, incentive intensity at the first incentive level is 1.1 times an incentive standard fee. In this case, incentive intensity at the second incentive level is 1.2 times the incentive standard fee, or vice versa. Setting of the incentive level is not limited in this embodiment of this application.

In consideration that the terminal can achieve different sensing precision when the terminal executes the sensing service, sensing precision at different levels may be used as statistical granularities. In an example, if the achieved sensing precision is 90% when the terminal executes the sensing service, it is determined that the terminal is at the first incentive level. If the achieved sensing precision is 80% when the terminal executes the sensing service, it is determined that the terminal is at the second incentive level. If all achieved sensing precision is 90% when a plurality of terminals execute the sensing service, it may be determined that all the terminals are at the first incentive level.

It should be understood that the foregoing statistical granularities may be properly combined. For example, after the sensing service type executed by the terminal is determined, classified statistics may continue to be further collected based on different sensing precision when the terminal executes the sensing service. In an example, a terminal that executes the environment type of sensing service and whose sensing precision reaches 90% when executing the service may be determined to be at the first incentive level.

The incentive parameter includes at least one of the statistical mode, the statistical event, or the threshold of the statistical event.

The statistical mode includes at least one of traffic-based statistics, duration-based statistics, or service occurrence quantity-based statistics.

The statistical event includes at least one of the following: traffic reaches a threshold, duration reaches a threshold, a service occurrence quantity reaches a threshold, a location at which the terminal executes the sensing service changes, or a time point at which the terminal executes the sensing service changes.

The threshold of the statistical event includes at least one of a traffic threshold, a duration threshold, or a service occurrence quantity threshold.

In an example, when the statistical mode is traffic-based statistics, the statistical event is that the traffic reaches the threshold, and the threshold of the statistical event is the traffic threshold. For example, when the terminal executes the sensing service, each time consumed traffic reaches the traffic threshold, the SDPF updates the contribution of the terminal, and sends contribution information to the SSCF. For example, when the terminal provides traffic of 10 M when executing the sensing service, the contribution of the terminal is 1; or if provided traffic is 100 M, the contribution of the terminal is 10.

In an example, when the statistical mode is duration-based statistics, the statistical event is that the duration reaches the threshold, and the threshold of the statistical event is the duration threshold. For example, when the terminal executes the sensing service, each time duration of executing the service reaches the duration threshold, the SDPF updates the contribution of the terminal, and sends the contribution information to the SSCF. For example, when the terminal has executed the sensing service 10 minutes, the contribution of the terminal is 1; or if the terminal has executed the sensing service 100 minutes, the contribution of the terminal is 10.

In an example, when the statistical mode is service occurrence quantity-based statistics, the statistical event is that the service occurrence quantity reaches the threshold, and the threshold of the statistical event is the service occurrence quantity threshold. For example, when the terminal executes the sensing service, each time a quantity of times of executing the service reaches the quantity threshold, the SDPF updates the contribution of the terminal, and sends the contribution information to the SSCF. For example, if the terminal has executed the sensing service one time, the contribution of the terminal is 1; or if the terminal has executed the sensing service 10 times, the contribution of the terminal is 10.

In an example, a zone in which the terminal executes the sensing service may be divided into a plurality of zones, for example, may be divided into a core service zone and a non-core service zone. The service zone may be divided by the SSCF. In the core service zone, there is a high requirement for the sensing service. In the non-core service zone, there is a low requirement for the sensing service. Contribution of the terminal when the terminal executes the sensing service in the core zone may be 1.5 times contribution of the terminal when the terminal executes the sensing service in the non-core zone. It should be understood that the service zone may be divided in various manners. The service zone may be divided into three or more zones, and an area of each service zone may be freely divided. A quantity of service zones obtained through division and an area of each service zone are not limited in this embodiment of this application.

In an example, a time period in which the terminal executes sensing service may be divided into a plurality of time periods. For example, a time period from 8:00 a.m. to 18:00 p.m. of Beijing time may be classified into a service peak time period, and the remaining time of a current day may be divided into a service off-peak time period. Contribution of the terminal when the terminal executes the sensing service in the service peak time period may be 1.5 times contribution of the terminal when the terminal executes the sensing service in the service off-peak time period. It should be understood that the time period may be divided in a plurality of manners. Time of one day may be divided into three, four, or more time periods, and a length of each time period may also be freely divided. A quantity of time periods obtained through division and a division length are not limited in this embodiment of this application.

S470: The SSCF indicates the base station to send a sensing signal to the terminal.

In this embodiment, the base station serves as a sender of the sensing signal in the sensing service, and sends the sensing signal to the terminal.

In another embodiment provided in this application, the terminal may alternatively be both a sender of the sensing signal in the sensing service and a receiver of the sensing signal.

S480: The terminal receives the sensing signal, and executes the sensing service.

S490: The terminal sends, to the base station, sensing data obtained after executing the sensing service.

In this embodiment, the terminal generates the sensing data when executing the sensing service, for example, provides, for the sensing service, specific traffic data, time data used for executing the sensing service, and data of the quantity of times of executing the sensing service.

S491: The base station transparently transmits the sensing data to the SDPF, and the SDPF receives the sensing data.

In another embodiment provided in this application, the SSCF may send the incentive policy and the incentive parameter to the base station, and indicate the base station to process the sensing data. In this case, S491 is not performed. In this case, the base station may directly perform integration processing on the sensing data, and collect statistics about the contribution of the terminal.

S492: The SDPF receives the sensing data, and the SDPF determines the contribution information of the terminal based on the sensing data.

S493: The SDPF sends the contribution information of the terminal to the SSCF, where the contribution information indicates the SSCF to send the contribution information to the CHF.

The contribution information is determined based on the contribution of the terminal. For example, the terminal may simultaneously execute a plurality of different sensing services. When executing different sensing services, the SDPF may collect statistics about the contribution of the terminal based on different incentive parameters. For example, when the terminal executes the environment type of service, the SDPF collects statistics about the contribution of the terminal based on traffic information of the sensing service. When the terminal executes the monitoring type of service, the SDPF collects statistics about the contribution of the terminal based on duration information of the sensing service. The contribution information may include a set of results of collecting statistics about the contribution in the two different methods. Certainly, the terminal may alternatively execute another sensing service, and the SDPF may alternatively collect statistics about the contribution of the terminal based on another incentive parameter.

S494: The SSCF sends the contribution information to the CHF, where the contribution information is used to request the CHF to incentivize the terminal.

The CHF generates a reconciliation statement based on the contribution information, and sends the reconciliation statement to an accounting system, to incentivize the terminal that executes the sensing service.

An incentive for the terminal that executes the sensing service may be reducing a charging bill of the terminal. For example, the incentive may be reducing a charging bill of the terminal by 10 yuan. For another example, the incentive may be a discount on a charging bill.

Based on the foregoing solution, after the terminal executes the sensing service, the SDPF may collect statistics about the contribution made by the terminal in the sensing service, and report the contribution information to the CHF; and the CHF may provide an incentive for the terminal based on the contribution information. If the terminal receives an incentive because the terminal executes the sensing service, it is more likely that the terminal executes the sensing service. In this way, motivation and initiative of the terminal to provide resources for the sensing service can be improved.

In the foregoing solution, the terminal is the receiver of the sensing signal. After receiving the sensing signal, the terminal executes the sensing service, and sends the sensing data. In a possible implementation, the terminal may be the sender of the sensing signal, send the sensing signal to the base station, and execute the sensing service. The following describes a technical solution in which the terminal serves as the sender of the sensing signal in the sensing service.

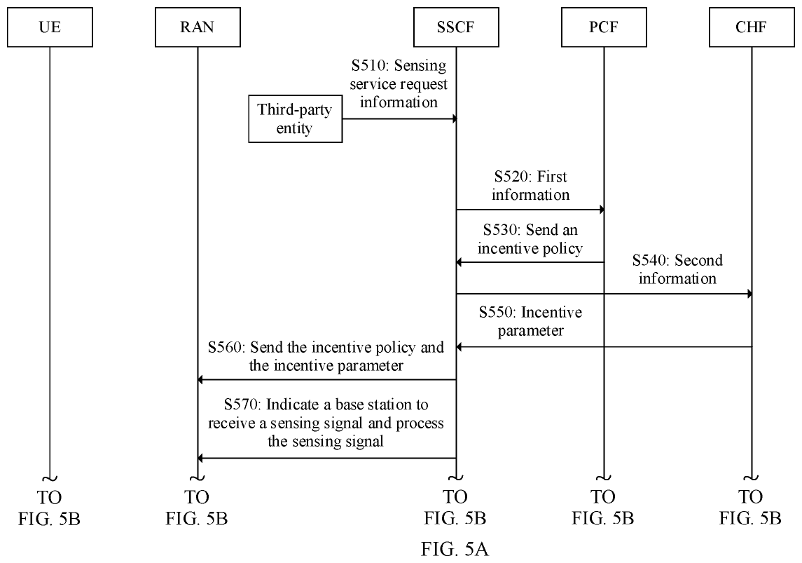

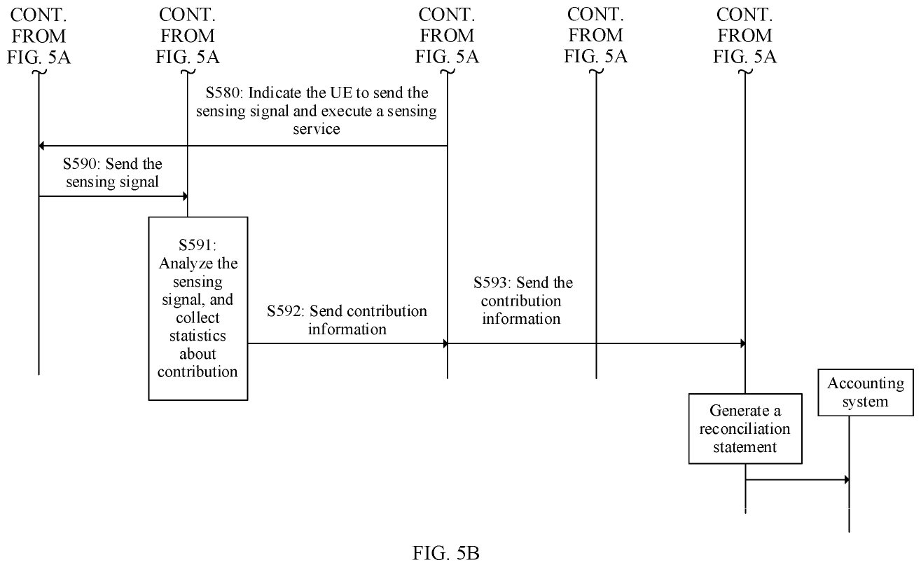

FIG. 5A and FIG. 5B are an interaction diagram of another method for incentivizing a terminal according to an embodiment of this application.

S510: A third-party entity sends sensing service request information to an SSCF. The SSCF receives the sensing service request information from the third-party entity.

S511: The SSCF determines that a sensing entity includes a terminal.

S520: The SSCF sends first information to a PCF, where the first information is used to request an incentive policy. The PCF receives the first information.

When determining that the sensing entity includes the terminal, the SSCF sends the first information to the PCF to request the incentive policy.

S530: The PCF receives the first information sent by the SSCF, where the first information is used by the SSCF to request the incentive policy. The PCF sends the incentive policy to the SSCF. The SSCF receives the incentive policy sent by the PCF.

S540: The SSCF sends second information to a CHF, where the second information is used to request an incentive parameter. The CHF receives the second information.

S550: The CHF receives the second information sent by the SSCF, where the second information is used by the SSCF to request the incentive parameter. The CHF sends the incentive parameter to the SSCF. The SSCF receives the incentive parameter.

S560: The SSCF sends the incentive policy and the incentive parameter to a base station, where the incentive policy and the incentive parameter are used by the base station to collect statistics about contribution of the terminal in the sensing service. The base station receives the incentive policy and the incentive parameter.

In this embodiment, the SSCF does not send the incentive policy and the incentive parameter to an SDPF; instead, directly sends the incentive policy and the incentive parameter to the base station, and indicates the base station to collect statistics about the contribution of the terminal.

It should be understood that, for S510 to S560, refer to related descriptions of S410 to S460. For brevity, details are not described herein again.

S570: The SSCF indicates the base station to receive the sensing signal sent by the terminal.

In this embodiment, the terminal serves as a sender of the sensing signal in the sensing service, and sends the sensing signal to the base station. In this case, the base station is a receiver of the sensing signal.

In another embodiment provided in this application, the terminal may alternatively be both a sender or a receiver of the sensing signal in a sensing service.

S580: The SSCF indicates the terminal to send the sensing signal to the base station and execute the sensing service.

S590: The terminal sends the sensing signal to the base station after executing the sensing service.

In this embodiment, the terminal is the sender of the sensing signal, and does not directly send the sensing data to the base station.

S591: After the base station receives the sensing signal sent by the terminal, the base station collects statistics about the contribution of the terminal based on the incentive policy and the incentive parameter.

In this embodiment, after receiving the sensing signal, the base station decodes the sensing signal to obtain the sensing data, and collects statistics about the contribution of the terminal.

S592: The base station sends contribution information of the terminal to the SSCF, where the contribution information is determined based on the contribution of the terminal.

S593: The SSCF sends the contribution information to the CHF, where the contribution information is used to request the CHF to incentivize the terminal.

The CHF generates a reconciliation statement based on the contribution information, and sends the reconciliation statement to an accounting system, to incentivize the terminal that executes the sensing service.

Based on the foregoing solution, the base station receives the incentive policy and the incentive parameter, and decodes the sensing signal sent by the terminal to obtain the sensing data, to collect statistics about the contribution of the terminal. Because the SDPF cannot process the sensing signal, but the base station may process the sensing signal sent by the terminal and obtain the sensing data, even if the terminal sends the sensing signal, the base station can still collect statistics about the contribution of the terminal.

In a possible implementation, two or more terminals may execute a same sensing service. In this case, a plurality of terminals that execute the same sensing service may be grouped into a terminal group, and statistics about contribution of the terminal group is collected.

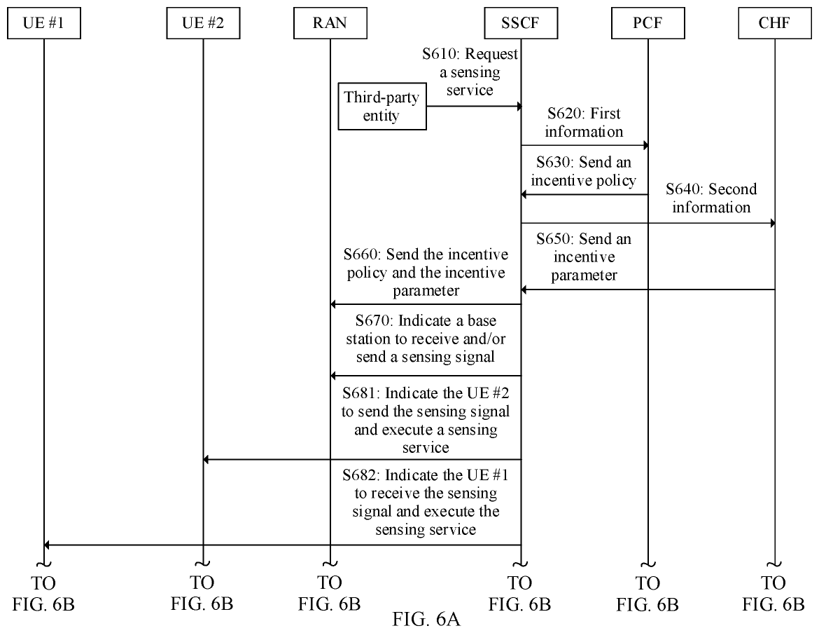

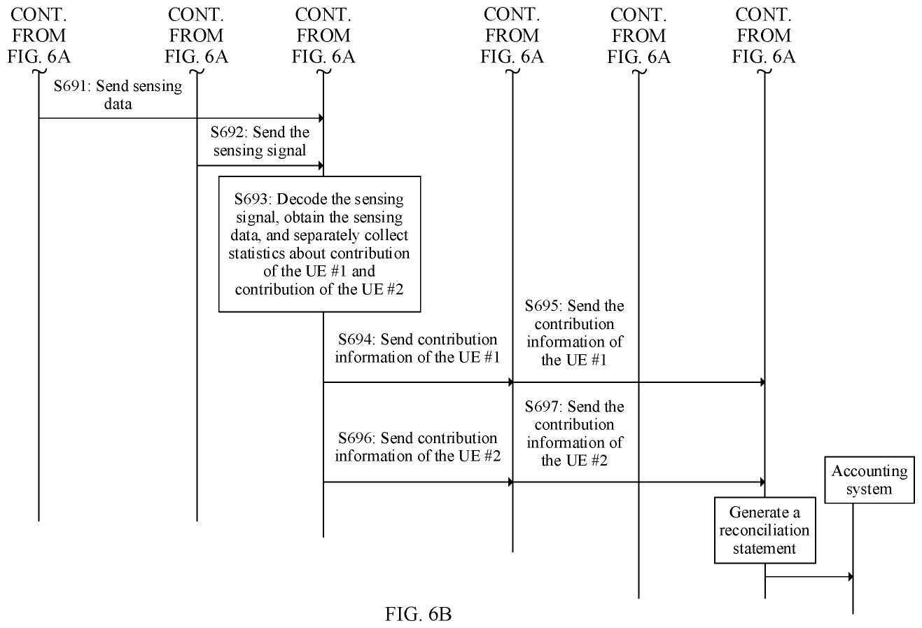

FIG. 6A and FIG. 6B are an interaction diagram of another method for incentivizing a terminal according to an embodiment of this application.

S610: A third-party entity sends sensing service request information to an SSCF. The SSCF receives the sensing service request information from the third-party entity.

S611: The SSCF determines that a sensing entity includes a terminal, for example, UE #1 and UE #2 in FIG. 6A and FIG. 6B.

S620: Send first information to a PCF, where the first information is used to request an incentive policy. The PCF receives the first information.

In this embodiment, when determining that the sensing entity includes the terminal, the SSCF sends the first information to the PCF to request the incentive policy.

S630: The PCF receives the first information sent by the SSCF, where the first information is used by the SSCF to request the incentive policy. The PCF sends the incentive policy to the SSCF. The SSCF receives the incentive policy sent by the PCF.

S640: The SSCF sends second information to a CHF, where the second information is used to request an incentive parameter. The CHF receives the second information.

S650: The CHF receives the second information sent by the SSCF, where the second information is used by the SSCF to request the incentive parameter. The CHF sends the incentive parameter to the SSCF. The SSCF receives the incentive parameter.

S660: The SSCF sends the incentive policy and the incentive parameter to a base station, where the incentive policy and the incentive parameter are used by the base station to collect statistics about contribution of the terminal in a sensing service. The base station receives the incentive policy and the incentive parameter.

In this embodiment, the SSCF does not send the incentive policy and the incentive parameter to an SDPF; instead, directly sends the incentive policy and the incentive parameter to the base station, and indicates the base station to collect statistics about the contribution of the terminal.

It should be understood that, for S610 to S660, refer to related descriptions of S410 to S460. For brevity, details are not described herein again.

S670: The SSCF indicates the base station to receive sensing data sent by the UE #1 and receive a sensing signal sent by the UE #2.

S681: The SSCF indicates the UE #2 to send the sensing signal to the base station and execute the sensing service.

S682: The SSCF indicates the UE #1 to receive the sensing signal sent by the base station and execute the sensing service.

It should be understood that there is no specific execution sequence between S681 and S682, or S682 may be performed before S681.

In another embodiment provided in this application, the SSCF may indicate both the UE #1 and the UE #2 to send sensing signals. In this case, the corresponding base station receives the sensing signals sent by the UE #1 and the UE #2, and the base station decodes the sensing signals to obtain sensing data. Alternatively, the SSCF may indicate the base station to send the sensing signal to both the UE #1 and the UE #2. In this case, the corresponding UE #1 and the corresponding UE #2 receive the sensing signal, execute the sensing service, and generate sensing data. In this embodiment of this application, sending or receiving of the sensing signal by UE is not limited.

S691: The UE #1 sends the sensing data to the base station.

S692: The UE #2 sends the sensing signal to the base station.

It should be understood that there is no specific execution sequence between S691 and S692. S692 may be performed before S691, or S691 and S692 may be performed simultaneously. For example, the UE #2 may first complete the sensing service, and first send the sensing signal.

S693: The base station receives the sensing data sent by the UE #1 and the sensing signal sent by the UE #2, and the base station collects statistics about amounts of contribution of the UE #1 and the UE #2 based on the incentive policy and the incentive parameter.

S694: The base station sends contribution information of the UE #1 to the SSCF, where the contribution information of the UE #1 indicates the SSCF to send the contribution information of the UE #1 to the CHF.

S695: The SSCF sends the contribution information to the CHF, where the contribution information of the UE #1 is used to request the CHF to incentivize the UE #1.

S696: The base station sends contribution information of the UE #2 to the SSCF, where the contribution information indicates the SSCF to send the contribution information of the UE #2 to the CHF.

S697: The SSCF sends the contribution information of the UE #2 to the CHF, where the contribution information is used to request the CHF to incentivize the UE #2.

The CHF generates a reconciliation statement based on the contribution information, and sends the reconciliation statement to an accounting system, to incentivize the terminal that executes the sensing service.

It should be understood that there is no specific execution sequence between S694 and S696, or S696 may be performed before S694.

Based on the foregoing solution, terminals that execute a same sensing service are grouped into one terminal group, and statistics about contribution of each terminal in the terminal group is separately collected, thereby improving efficiency of processing sensing data by a second network element.

To improve fairness in collecting statistics about the contribution of the terminal, an incentive smart contract may be introduced, so that statistics about the contribution of the terminal is more accurate, and further, the terminal obtains a more accurate incentive.

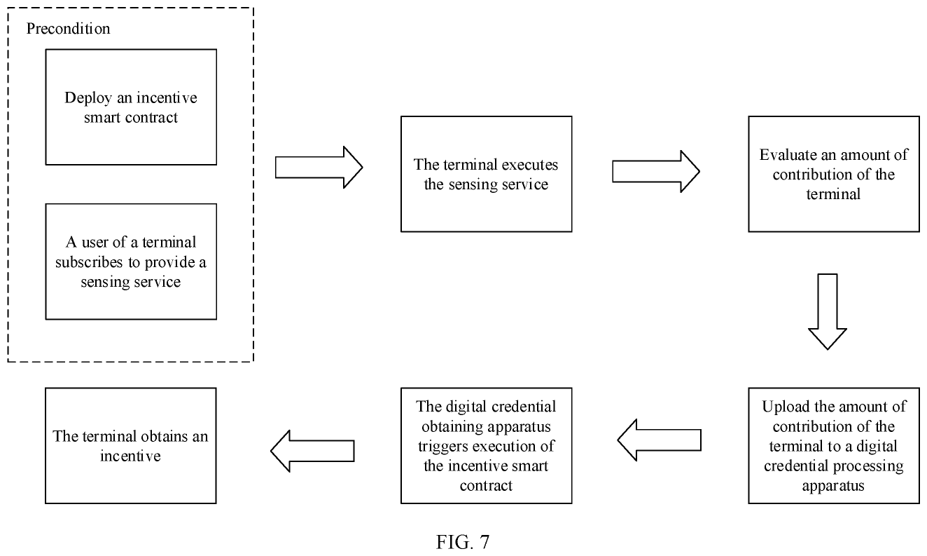

FIG. 7 is a schematic flowchart of deploying an incentive smart contract in a digital credential processing apparatus, which is applicable to an embodiment of this application.

After a terminal has been subscribed to provide a sensing service, the incentive smart contract is deployed in the digital credential processing apparatus. Content of the incentive smart contract may be determined based on the foregoing content of the incentive policy and the incentive parameter. For example, contribution information of the terminal is determined based on traffic information of sensing data provided by the terminal when the terminal executes the sensing service.

After the contribution information of the terminal is uploaded to the digital credential processing apparatus, execution of the incentive smart contract of the digital credential processing apparatus may be triggered, and the incentive smart contract determines, based on the contribution information, how to incentivize the terminal.

The incentive smart contract is deployed in the digital credential processing apparatus, so that a programmatic design can be used to satisfy contract determining logic, which can reduce occurrence and maliciousness of an accidental abnormality, and reduce a requirement for a trusted intermediary. In addition, after the incentive smart contract is executed, an execution result is reconcilable, traceable, and tamper-proof, which may meet a supervision requirement.

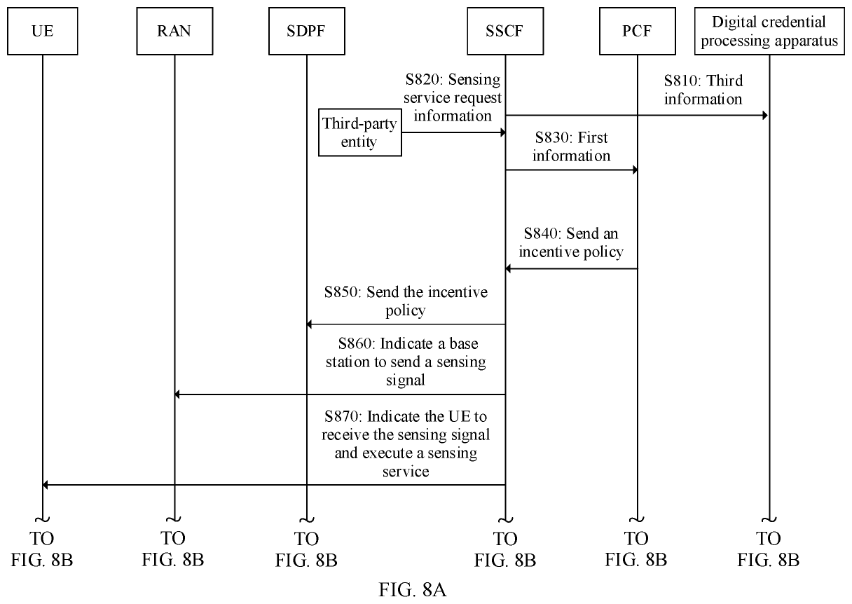

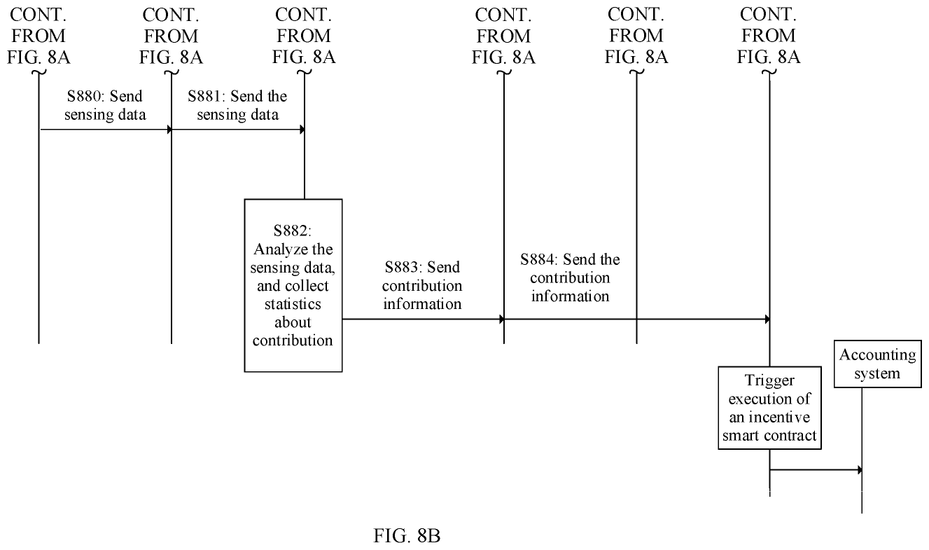

FIG. 8A and FIG. 8B are an interaction diagram of another method for incentivizing a terminal according to an embodiment of this application.

S810: An SSCF sends third information to a digital credential processing apparatus when a terminal has been subscribed to provide a sensing service, where the third information is used to request the digital credential processing apparatus to deploy an incentive smart contract. The digital credential processing apparatus receives the third information.

The digital credential processing apparatus deploys the incentive smart contract in response to the third information.

In an example, when the terminal has been subscribed to provide the sensing service, or when subscription information of the terminal regarding the provision of the sensing service is changed, subscription authentication information is sent to a unified data management function (UDM). After receiving the subscription authentication information, the UDM sends indication information to the SSCF. The SSCF sends the third information only after receiving the indication information.

In an example, there may be various forms in which the terminal may be subscribed to provide the sensing service. For example, a user may handle the subscription for providing the sensing service at an offline service hall. For another example, a user may request activation for providing the sensing service by sending an SMS message. For still another example, a user may request activation for providing the sensing service in some applications.

S820: A third-party entity sends sensing service request information to the SSCF. The SSCF receives the sensing service request information from the third-party entity.

S821: The SSCF determines that a sensing entity includes the terminal.

It should be understood that, in a sensing service, a sensing entity that may perform the sensing service may be a network device or a terminal, and one or more sensing entities may perform the sensing service. In this embodiment of this application, because the terminal needs to be incentivized, the SSCF needs to determine that the sensing entity that executes the sensing service includes the terminal, and then continues to execute a corresponding incentive procedure.

The SSCF may determine, based on a device type, that the sensing entity includes the terminal. The terminal needs to be incentivized only when the sensing entity includes the terminal. If the sensing entity is a network device, the network device does not need to be incentivized.

S830: The SSCF sends first information to a PCF, where the first information is used to request an incentive policy. The PCF receives the first information.

When determining that the sensing entity includes the terminal, the SSCF sends the first information to the PCF to request the incentive policy.

S840: The PCF receives the first information sent by the SSCF, where the first information is used by the SSCF to request the incentive policy. The PCF sends the incentive policy to the SSCF. The SSCF receives the incentive policy sent by the PCF.

In this embodiment, the incentive policy received by the SSCF includes an incentive parameter. Therefore, the SSCF no longer requests the incentive parameter from the CHF.

S850: The SSCF sends the incentive policy to an SDPF, where the incentive policy is used by the SDPF to collect statistics about contribution of the terminal in the sensing service. The SDPF receives the incentive policy.

It should be understood that, for S820 to S850, refer to related descriptions of S410 to S460. For brevity, details are not described herein again.

S860: The SSCF indicates a base station to send a sensing signal to the terminal.

S870: The terminal receives the sensing signal, and executes the sensing service.

S880: The terminal sends, to the base station, sensing data obtained after executing the sensing service.

S881: The base station transparently transmits the sensing data to the SDPF, and the SDPF receives the sensing data.

S882: The SDPF receives the sensing data, and the SDPF determines contribution information of the terminal based on the sensing data.

S883: The SDPF sends the contribution information of the terminal to the SSCF, where the contribution information indicates the SSCF to send the contribution information to the digital credential processing apparatus.

S884: The SSCF sends the contribution information to the digital credential processing apparatus, where the contribution information is used to request the digital credential processing apparatus to incentivize the terminal.

In this embodiment, the digital credential processing apparatus has been deployed with the incentive smart contract. The digital credential processing apparatus may automatically trigger execution of the incentive smart contract based on the contribution information, and report an execution result to an accounting system, to incentivize the terminal.

Based on the foregoing technical solution, the incentive smart contract may accurately collect statistics based on the reported contribution information, to provide an accurate incentive amount for the terminal.

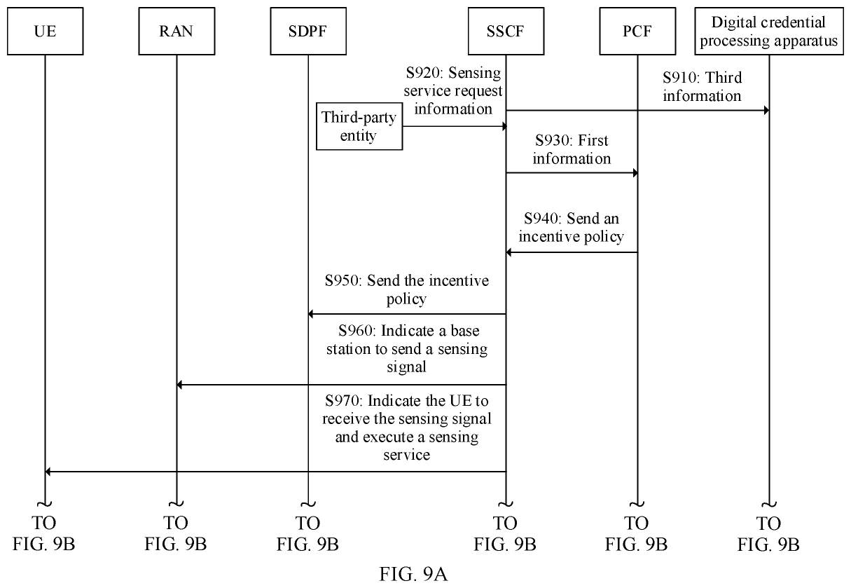

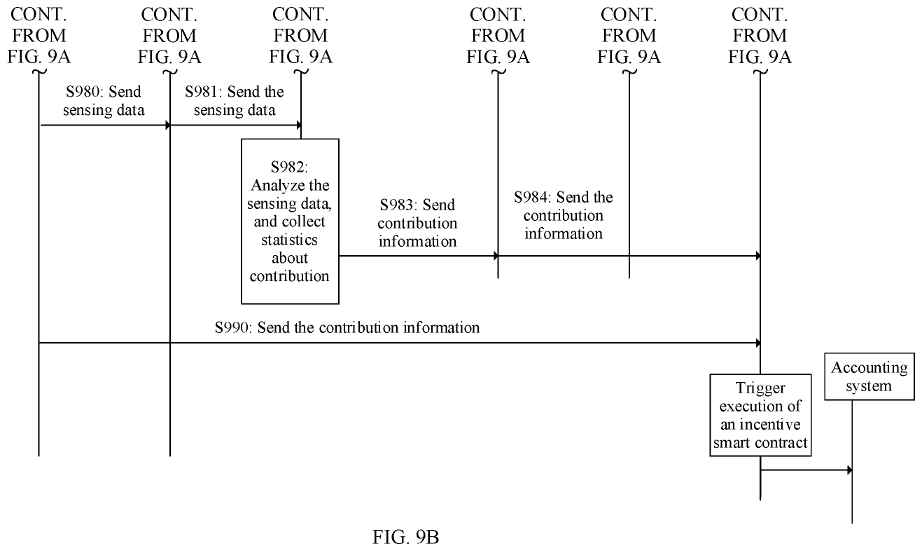

FIG. 9A and FIG. 9B are an interaction diagram of another method for incentivizing a terminal according to an embodiment of this application.

S910: An SSCF sends third information to a digital credential processing apparatus when a terminal has been subscribed to provide a sensing service, where the third information is used to request the digital credential processing apparatus to deploy an incentive smart contract. The digital credential processing apparatus receives the third information.

The digital credential processing apparatus deploys the incentive smart contract in response to the third information.

In an example, when the terminal has been subscribed to provide the sensing service, or when subscription information of the terminal regarding the provision of the sensing service is changed, subscription authentication information is sent to a unified data management function (UDM). After receiving the subscription authentication information, the UDM sends indication information to the SSCF. The SSCF sends the third information only after receiving the indication information.

In an example, there may be various forms in which the terminal may be subscribed to provide the sensing service. For example, a user may handle the subscription for providing the sensing service at an offline service hall. For another example, a user may request activation for providing the sensing service by sending an SMS message. For still another example, a user may request activation for providing the sensing service in some applications.

S920: A third-party entity sends sensing service request information to the SSCF. The SSCF receives the sensing service request information from the third-party entity.

S921: The SSCF determines that a sensing entity includes the terminal.

In a sensing service, a sensing entity that may execute the sensing service may be a network device or a terminal. In this embodiment of this application, because the terminal needs to be incentivized, the SSCF needs to determine that the sensing entity includes the terminal, and then continue to execute an incentive policy.

The SSCF may determine, based on a device type, that the sensing entity includes the terminal. The terminal needs to be incentivized only when the sensing entity includes the terminal. If the sensing entity is a network device, the network device does not need to be incentivized.

S930: The SSCF sends first information to a PCF, where the first information is used to request the incentive policy. The PCF receives the first information.

When determining that the sensing entity includes the terminal, the SSCF sends the first information to the PCF to request the incentive policy.

S940: The PCF receives the first information sent by the SSCF, where the first information is used by the SSCF to request the incentive policy; and sends the incentive policy to the SSCF. The SSCF receives the incentive policy sent by the PCF.

In this embodiment, the incentive policy received by the SSCF includes an incentive parameter. Therefore, the SSCF no longer requests the incentive parameter from a CHF.

S950: The SSCF sends the incentive policy to an SDPF, where the incentive policy is used by the SDPF to collect statistics about contribution of the terminal in the sensing service. The SDPF receives the incentive policy.

It should be understood that, for S920 to S950, refer to related descriptions of S410 to S460. For brevity, details are not described herein again.

In this embodiment, the SSCF may send the incentive policy to the terminal. In this case, the terminal may collect statistics about the contribution of the terminal.

S960: The SSCF indicates a base station to send a sensing signal to the terminal.

S970: The terminal receives the sensing signal, and executes the sensing service.

S980: The terminal sends, to the base station, sensing data obtained after executing the sensing service.

S981: The base station transparently transmits the sensing data to the SDPF, and the SDPF receives the sensing data.

S982: The SDPF receives the sensing data, and the SDPF determines contribution information of the terminal based on the sensing data.

S983: The SDPF sends the contribution information of the terminal to the SSCF, where the contribution information indicates the SSCF to send the contribution information to the digital credential processing apparatus.

S984: The SSCF sends the contribution information to the digital credential processing apparatus, where the contribution information is used to request the digital credential processing apparatus to incentivize the terminal.

S990: The terminal collects statistics about the contribution of the terminal, and uploads the contribution information to the digital credential processing apparatus.

In an example, the terminal may collect statistics about contribution made by the terminal when the terminal executes the sensing service, for example, collect statistics about traffic contributed by the terminal when the terminal executes the sensing service, and collect statistics about data such as time spent by the terminal when the terminal executes the sensing service.

In this embodiment, the digital credential processing apparatus has been deployed with the incentive smart contract, and receives the contribution information sent by the terminal and the contribution information sent by the SSCF. The digital credential processing apparatus compares the amounts of contribution information sent by the two sides; and if amounts of contribution from the two sides are consistent, may trigger execution of the incentive smart contract, and report an execution result to the accounting system, to incentivize the terminal.

Based on the foregoing technical solution, the digital credential processing apparatus compares the contribution information sent by the terminal with the contribution information sent by the SSCF, and triggers execution of the incentive smart contract if the contribution information sent by the terminal is consistent with the contribution information sent by the SSCF. In this way, accuracy of the contribution information of the terminal can be improved, and the terminal can be more correctly incentivized.

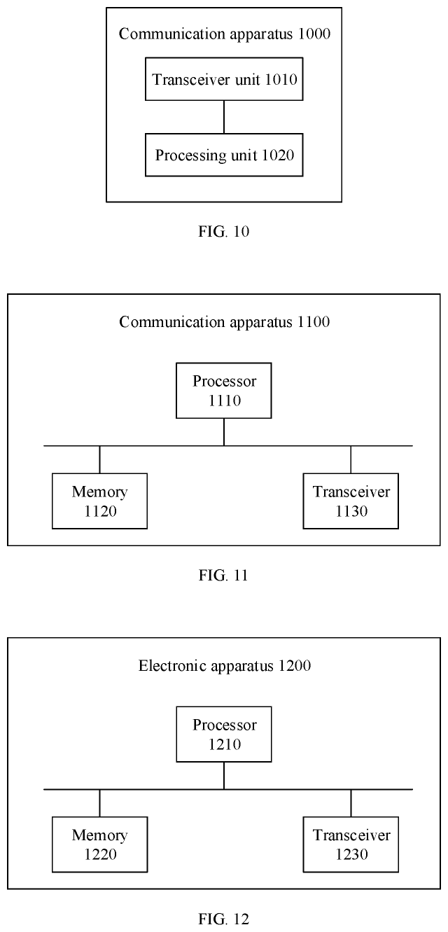

The methods provided in embodiments of this application are described in detail above with reference to FIG. 3 to FIG. 9B. Apparatuses provided in embodiments of this application are described in detail below with reference to FIG. 10 and FIG. 12. It should be understood that descriptions of apparatus embodiments correspond to the descriptions of the method embodiments. Therefore, for content that is not described in detail, refer to the foregoing method embodiments. For brevity, details are not described herein again.

The apparatus is configured to implement the foregoing embodiments and related implementations, and details that have been described are not repeated. As used in the following, the term “module” may be a combination of software and/or hardware that implement/implements a predetermined function. Although the apparatus described in the following embodiments is preferably implemented by software, implementation of hardware or a combination of software and hardware may also be conceived.

FIG. 10 is a diagram of an architecture of a communication apparatus according to an embodiment of this application. The communication apparatus 1000 includes a transceiver unit 1010 and a processing unit 1020. The transceiver unit 1010 may be configured to implement a corresponding communication function, and the processing unit 1020 may be configured to perform data processing.

In an example, the transceiver unit 1010 may also be referred to as a communication interface or a communication unit, and includes a sending unit and/or a receiving unit. The transceiver unit 1010 may be a transceiver (including a transmitter and/or a receiver), an input/output interface (including an input interface and/or an output interface), a pin, a circuit, or the like. The transceiver unit 1010 may be configured to perform a sending step and/or a receiving step in the foregoing method embodiments.

In an example, the processing unit 1020 may be a processor (may include one or more processors), a processing circuit having a processor function, or the like, and may be configured to perform a step other than sending and receiving in the foregoing method embodiments.

In an example, the communication apparatus 1000 further includes a storage unit. The storage unit may be a memory, an internal storage unit (for example, a register or a cache), an external storage unit (for example, a read-only memory or a random access memory), or the like. The storage unit is configured to store instructions. The processing unit 1020 executes the instructions stored in the storage unit, so that the communication apparatus performs the foregoing methods.

In a design, the communication apparatus 1000 may be configured to perform the actions performed by the second network element in the foregoing method embodiments. The second network element may be an SDPF or a base station. For example, the communication apparatus 1000 may be configured to perform the actions performed by the second network element in the foregoing methods. In this case, the communication apparatus 1000 may be a constituent part of the second network element. The transceiver unit 1010 is configured to perform a receiving and sending-related operation of the second network element in the foregoing method embodiments. The processing unit 1020 is configured to perform a processing-related operation of the second network element in the foregoing method embodiments.

For example, the transceiver unit 1010 is configured to receive a sensing incentive policy and an incentive parameter; and the processing unit 1020 is configured to process sensing data.

In an example, the transceiver unit 1010 may further perform another operation performed by the first network element in any one of the foregoing methods. The first network element may be an SSCF. Details are not described herein again.

In an example, the transceiver unit 1010 may further perform another operation performed by the third network element in any one of the foregoing methods. The third network element may be a PCF. Details are not described herein again.

In a design, the apparatus 1000 may be configured to perform the actions performed by the fourth network element in the foregoing method embodiments. The fourth network element may be a CHF. For example, the apparatus 1000 may be configured to perform the actions performed by the fourth network element in the foregoing methods. In this case, the apparatus 1000 may be a constituent part of the fourth network element. The transceiver unit 1010 is configured to perform a receiving and sending-related operation of the fourth network element in the foregoing method embodiments. The processing unit 1020 is configured to perform a processing-related operation of the fourth network element in the foregoing method embodiments.

For example, the transceiver unit 1010 is configured to receive second information; and the processing unit 1020 is configured to incentivize a terminal based on contribution information.

It should be understood that the transceiver unit 1010 and the processing unit 1020 may further perform another operation performed by the fourth network element in any one of the foregoing methods. Details are not described one by one herein again.

It should be further understood that, the apparatus 1000 herein is embodied in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. A person skilled in the art may understand that the apparatus 1000 may be specifically the network device in the foregoing embodiments, and may be configured to perform procedures and/or steps corresponding to the network device in the foregoing method embodiments. To avoid repetition, details are not described herein again.

The apparatus 1000 in the foregoing solutions has a function of implementing a corresponding step performed by the device in the foregoing methods, or the apparatus 1000 in the foregoing solutions has a function of implementing a corresponding step performed by the access network device in the foregoing methods. The function may be implemented by hardware, or may be implemented by executing corresponding software by hardware. The hardware or software includes one or more modules corresponding to the foregoing function. For example, a transceiver unit may be replaced with a transceiver (for example, a sending unit in the transceiver unit may be replaced with a transmitter, and a receiving unit in the transceiver unit may be replaced with a receiver), and another unit such as a processing unit may be replaced with a processor, to separately perform sending and receiving operations and a related processing operation in the method embodiments.

In addition, the transceiver unit 1010 may alternatively be a transceiver circuit (for example, the transceiver circuit may include a receiving circuit and a sending circuit), and the processing unit may be a processing circuit.

It should be noted that the apparatus in FIG. 10 may be the network element or the device in the foregoing embodiments, or may be a chip or a chip system, for example, a system-on-chip (SoC). The transceiver unit may be an input/output circuit or a communication interface. The processing unit is a processor, a microprocessor, or an integrated circuit integrated on the chip. This is not limited herein.

FIG. 11 is a diagram of another communication apparatus according to an embodiment of this application. A communication apparatus 1100 shown in FIG. 11 includes one or more of a processor 1110, a memory 1120, or a transceiver 1130. The processor 1110 is coupled to a memory 1120, and is configured to execute instructions stored in the memory 1120, to control the transceiver 1130 to send a signal and/or receive a signal.

It should be understood that, the processor 1110 and the memory 1120 may be combined into one processing apparatus, and the processor 1110 is configured to execute program code stored in the memory 1120 to implement the foregoing functions. In specific implementation, the memory 1120 may be integrated into the processor 1110, or may be independent of the processor 1110. It should be understood that, the processor 1110 may correspond to each processing unit in the foregoing communication apparatus, and the transceiver 1130 may correspond to each receiving unit and sending unit in the foregoing communication apparatus.

It should be further understood that, the transceiver 1130 may include a receiver (or referred to as a receiver machine) and a transmitter (or referred to as a transmitter machine). The transceiver may further include an antenna, and there may be one or more antennas. The transceiver may alternatively be a communication interface or an interface circuit.

In an example, the communication apparatus 1100 may correspond to the first network element in the methods according to embodiments of this application, and the first network element may be an SSCF. The communication apparatus 1100 may perform the steps performed by the first network element in the foregoing methods. The communication apparatus 1100 may correspond to the second network element in the methods according to embodiments of this application, and the second network element may be an SDPF or a base station. The communication apparatus 1100 may perform the steps performed by the second network element in the foregoing methods. The communication apparatus 1100 may correspond to the third network element in the methods according to embodiments of this application, and the third network element may be a PCF. The communication apparatus 1100 may perform the steps performed by the third network element in the foregoing methods. The communication apparatus 1100 may correspond to the fourth network element in the methods according to embodiments of this application, and the fourth network element may be a CHF. The communication apparatus 1100 may perform the steps performed by the fourth network element in the foregoing methods. It should be understood that a specific process of the foregoing corresponding steps is described in detail in the foregoing method embodiments. For brevity, details are not described herein.

When the communication apparatus 1100 is a chip, the chip includes an interface unit and a processing unit. The interface unit may be an input/output circuit or a communication interface. The processing unit may be a processor, a microprocessor, or an integrated circuit integrated on the chip.

FIG. 12 is a diagram of an electronic apparatus according to an embodiment of this application. The electronic apparatus 1200 shown in FIG. 12 includes one or more of a processor 1210, a memory 1220, or a transceiver 1230. The processor 1210 is coupled to a memory 1220, and is configured to execute instructions stored in the memory 1220, to control the transceiver 1230 to send a signal and/or receive a signal.

It should be understood that, the processor 1210 and the memory 1220 may be combined into one processing apparatus, and the processor 1210 is configured to execute program code stored in the memory 1220 to implement the foregoing functions. In specific implementation, the memory 1220 may be integrated into the processor 1210, or may be independent of the processor 1210. It should be understood that, the processor 1210 may correspond to each processing unit in the foregoing communication apparatus, and the transceiver 1230 may correspond to each receiving unit and sending unit in the foregoing communication apparatus.

It should be further understood that, the transceiver 1230 may include a receiver (or referred to as a receiver machine) and a transmitter (or referred to as a transmitter machine). The transceiver may further include an antenna, and there may be one or more antennas. The transceiver may alternatively be a communication interface or an interface circuit.

In an example, the electronic apparatus 1200 may correspond to the digital credential processing apparatus in the methods according to embodiments of this application. The electronic apparatus 1200 may perform the steps performed by the digital credential processing apparatus in the foregoing methods. The electronic apparatus 1200 may correspond to the digital credential processing apparatus in the methods according to embodiments of this application. The electronic apparatus 1200 may perform the steps performed by the digital credential processing apparatus in the foregoing methods. It should be understood that a specific process of the foregoing corresponding steps is described in detail in the foregoing method embodiments. For brevity, details are not described herein.

When the electronic apparatus 1200 is a chip, the chip includes an interface unit and a processing unit. The interface unit may be an input/output circuit or a communication interface. The processing unit may be a processor, a microprocessor, or an integrated circuit integrated on the chip.

In an implementation process, steps in the foregoing methods can be implemented by using a hardware integrated logic circuit in the processor, or by using instructions in a form of software. The steps of the method disclosed with reference to embodiments of this application may be directly performed and completed by a hardware processor, or may be performed and completed by using a combination of hardware in the processor and a software module. A software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor. To avoid repetition, details are not described herein again.

It should be noted that, the processor in embodiments of this application may be an integrated circuit chip, and has a signal processing capability. In an implementation process, steps in the foregoing method embodiments can be implemented by using a hardware integrated logic circuit in the processor, or by using instructions in a form of software. The processor may be a general purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods, the steps, and logical block diagrams that are disclosed in embodiments of this application. The general-purpose processor may be a microprocessor, or the processor may be any conventional processor, or the like. The steps in the methods disclosed with reference to embodiments of this application may be directly performed and completed by a hardware decoding processor, or may be performed and completed by using a combination of hardware in the decoding processor and a software module. A software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor.

This application further provides a computer-readable medium storing a computer program. When the computer program is executed by a computer, functions of any one of the foregoing method embodiments are implemented.

This application further provides a computer program product. When the computer program product is executed by a computer, functions of any one of the foregoing method embodiments are implemented.

All or some of the foregoing embodiments may be implemented by using software, hardware, firmware, or any combination thereof. When software is used to implement the embodiments, all or a part of the embodiments may be implemented in a form of a computer program product. The computer program product includes one or more computer instructions. When the computer instructions are loaded and executed on a computer, all or some of the procedures or functions according to embodiments of this application are generated. The computer may be a general-purpose computer, a dedicated computer, a computer network, or other programmable apparatuses. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, through a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

In embodiments of this application, the term “example”, “for example”, or the like is used to represent giving an example, an illustration, or a description. Any embodiment or design scheme described as an “example” in embodiments of this application should not be explained as being more preferred or having more advantages than another embodiment or design scheme. Exactly, use of the word “for example” is intended to present a concept in a specific manner.

It should be understood that, an “embodiment” mentioned throughout this specification means that particular features, structures, or characteristics related to this embodiment are included in at least one embodiment of this application. Therefore, embodiments in the entire specification do not necessarily refer to a same embodiment. In addition, these particular features, structures, or characteristics may be combined in one or more embodiments by using any appropriate manner.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application. Names of all nodes and information in embodiments of this application are merely names set for ease of description in this application, and may be different in an actual network. It should not be understood that names of various nodes and information are limited in this application. On the contrary, any name that has a function that is the same as or similar to that of the node or the information used in embodiments of this application is considered as a method or an equivalent replacement in this application, and falls within the protection scope of this application.

It should be further understood that, in embodiments of this application, “when” and “if” mean that UE or a base station performs corresponding processing in an objective situation, but do not constitute any limitation on time, do not require the UE or the base station to perform a determining action during implementation, and do not mean other limitations either.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists.

The term “at least one of . . . ” in this specification represents all or any combination of listed items. For example, “at least one of A, B, and C” may represent the following six cases: Only A exists, only B exists, only C exists, both A and B exist, both B and C exist, and A, B, and C all exist. In this specification, “at least one” means one or more. “A plurality of” indicates two or more.

It should be understood that, the terms “include”, “have”, and their variants all mean “include but are not limited to”, unless otherwise specifically emphasized in another manner.

It should be understood that, in various embodiments of this application, first, second, and various numbers are merely for differentiation for ease of description, and are not for limiting the scope of embodiments of this application. For example, different information is differentiated.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed operating process of the foregoing described system, apparatus, and unit, refer to a corresponding process in the foregoing method embodiments. Details are not described herein again.

In the several embodiments provided in this application, it should be understood that the disclosed system, apparatus, and method may be implemented in another manner. For example, the described apparatus embodiment is merely an example. For example, division into the units is merely logical functional division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method for incentivizing a terminal, wherein the method comprises:
obtaining an incentive policy and obtaining an incentive parameter, wherein the incentive policy and the incentive parameter are used by a second network element to collect statistics about contribution of the terminal to a sensing service; and
sending the incentive policy and the incentive parameter to the second network element.

2. The method according to claim 1, wherein obtaining the incentive policy comprises:
sending first information to a third network element, wherein the first information is used to request the incentive policy; and
receiving the incentive policy from the third network element.

3. The method according to claim 1, wherein obtaining the incentive policy comprises:
obtaining the incentive policy from a local configuration.

4. The method according to claim 1, wherein the incentive policy is preconfigured, or the incentive policy is predefined.

5. The method according to claim 1, wherein obtaining the incentive parameter comprises:
sending second information to a fourth network element, wherein the second information is used to request the incentive parameter; and
receiving the incentive parameter from the fourth network element.

6. The method according to claim 1, wherein the incentive policy comprises a statistical granularity.

7. The method according to claim 6, wherein the statistical granularity comprises at least one of service type-based statistics, sensing precision-based statistics, or quality of service flow-based statistics.

8. The method according to claim 1, wherein the incentive parameter comprises at least one of the following:
a statistical mode, a statistical event, or a threshold of the statistical event.

9. The method according to claim 8, wherein at least one of:
the statistical mode comprises at least one of the following: traffic-based statistics, duration-based statistics, or sensing service occurrence quantity-based statistics;
the statistical event comprises at least one of the following: traffic reaches a threshold, duration reaches a threshold, a sensing service occurrence quantity reaches a threshold, a location at which the terminal executes the sensing service changes, or a time point at which the terminal executes the sensing service changes; or
the threshold of the statistical event comprises at least one of the following: a traffic threshold, a duration threshold, or a sensing service occurrence quantity threshold.

10. The method according to claim 1, wherein the method further comprises:
receiving contribution information from the second network element; and
sending the contribution information to a fourth network element in response to receiving the contribution information, wherein the contribution information is used to request the fourth network element to incentivize the terminal.

11. The method according to claim 1, wherein the method further comprises:
sending third information to a digital credential processing apparatus when the terminal has been subscribed to provide the sensing service, wherein the third information is used to request the digital credential processing apparatus to deploy an incentive smart contract.

12. The method according to claim 11, wherein the method further comprises:
receiving contribution information from the second network element; and
sending the contribution information to the digital credential processing apparatus in response to receiving the contribution information, wherein the contribution information is used to request the digital credential processing apparatus to incentivize the terminal.

13. A method for incentivizing a terminal, wherein the method comprises:
receiving sensing data;
determining contribution information of the terminal based on the sensing data; and
sending the contribution information of the terminal to a first network element, wherein the contribution information indicates the first network element to send the contribution information to a fourth network element.

14. The method according to claim 13, wherein the method further comprises:
receiving an incentive policy and an incentive parameter, wherein the incentive policy and the incentive parameter are used to collect statistics about contribution of the terminal to a sensing service.

15. The method according to claim 14, wherein the incentive policy comprises a statistical granularity.

16. The method according to claim 15, wherein the statistical granularity comprises at least one of service type-based statistics, sensing precision-based statistics, or quality of service flow-based statistics.

17. The method according to claim 14, wherein the incentive parameter comprises at least one of the following:
a statistical mode, a statistical event, or a threshold of the statistical event.

18. The method according to claim 17, wherein at least one of:
the statistical mode comprises at least one of the following: traffic-based statistics, duration-based statistics, or sensing service occurrence quantity-based statistics;
the statistical event comprises at least one of the following: traffic reaches a threshold, duration reaches a threshold, a sensing service occurrence quantity reaches a threshold, a location at which the terminal executes the sensing service changes, or a time point at which the terminal executes the sensing service changes; or
the threshold of the statistical event comprises at least one of the following: a traffic threshold, a duration threshold, a service occurrence quantity threshold, or a sensing precision threshold.

19. A method for incentivizing a terminal, wherein the method comprises:
receiving first information sent by a first network element, wherein the first information is used by the first network element to request an incentive policy; and
sending the incentive policy to the first network element.

20. The method according to claim 19, wherein the incentive policy comprises at least one of service type-based statistics, sensing precision-based statistics, or quality of service flow-based statistics.
